(19) United States
(12) Patent Application Publication
(10) Pub. No.: US 2020/0329366 A1
(43) Pub. Date: Oct. 15, 2020

(54) INFORMATION CONTROL METHOD, INFORMATION CONTROL DEVICE, AND STORAGE MEDIUM

(71) Applicant: FUJITSU LIMITED, Kawasaki-shi (JP)

(72) Inventors: Masafumi Katoh, Yokohama (JP); Junichi Suga, Ota (JP); SATOSHI IMAI, Kawasaki (JP); AKIKO YAMADA, Kawasaki (JP); Yuichi Yamagishi, Kawasaki (JP)

(73) Assignee: FUJITSU LIMITED, Kawasaki-shi (JP)

(21) Appl. No.: 16/835,709

(22) Filed: Mar. 31, 2020

(30) Foreign Application Priority Data
Apr. 10, 2019 (JP) 2019-075192

(51) Int. Cl. H04W 8/20; H04W 92/18; H04W 48/16; H04L 29/08

(52) U.S. Cl. CPC H04W 8/20; H04L 67/306; H04W 48/16; H04W 92/18

(57) ABSTRACT

A non-transitory computer-readable storage medium storing a program that causes a processor included in a computer to execute a process, the process includes transmitting a first profile indicating a feature of a first user to a device, acquiring a second profile indicating a feature of a second user from the device, establishing communication with the device, in accordance with association between the first profile and the acquired second profile, and notifying the device having the communication established of event information corresponding to a context indicating a state of the first user.

### CROSS-REFERENCE TO RELATED APPLICATION

This application is based upon and claims the benefit of priority of the prior Japanese Patent Application No. 2019-75192, filed on Apr. 10, 2019, the entire contents of which are incorporated herein by reference.

### FIELD

The embodiments discussed herein are related to an information control program, an information control method, and an information control device.

### BACKGROUND

These days, the amount of information that can be accessed by humans, like billions of Web sites, is so large that it is difficult for a person to view all of the information even over a lifetime. According to a recent survey, the number of Web sites is increasing by 100 million annually. For this reason, information control for providing information that matches each user is normally performed.

As a conventional technique for providing information that matches each user, there are communication devices and a communication system with which liking matching among people in the same space and time is performed so that information of interest already owned by users are exchanged. There are also information exchange devices capable of selecting information to be transmitted in accordance with the situation on the transmission side.

For example, Japanese Laid-open Patent Publication No. 2001-67400, Japanese Laid-open Patent Publication No. 2008-129886, and others are disclosed as related art.

### SUMMARY

According to an aspect of the embodiments, a non-transitory computer-readable storage medium storing a program that causes a processor included in a computer to execute a process, the process includes transmitting a first profile indicating a feature of a first user to a device, acquiring a second profile indicating a feature of a second user from the device, establishing communication with the device, in accordance with association between the first profile and the acquired second profile, and notifying the device having the communication established of event information corresponding to a context indicating a state of the first user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example functional, configuration of an information control device according to an embodiment;

FIGS. 2A and 2B are explanatory diagrams illustrating an example of profile information;

FIG. 3A is an explanatory diagram illustrating an example of the hierarchical structure of a profile;

FIG. 3B is an explanatory diagram illustrating an example of hierarchical structure of a profile;

FIG. 3C is an explanatory diagram illustrating an example of the hierarchical structure of a profile;

FIG. 3D is an explanatory diagram illustrating an example of the hierarchical structure of a profile;

FIG. 4 is a flowchart strafing an example operation of an information control device according to an embodiment;

FIG. 5 is an explanatory diagram illustrating inputs of demands (requests/requirements/likings) or supplies (supply specifications/providing skills) to virtual selves;

FIG. 6 is an explanatory diagram illustrating exchanges of profiles;

FIG. 7 is an explanatory diagram for explaining relationship construction;

FIG. 8A is a flowchart illustrating an example of a relationship construction process;

FIG. 8B is a flowchart illustrating an example of a relationship construction process;

FIGS. 8C and 8D are flowcharts illustrating an example of relationship construction process;

FIG. 9 is an explanatory diagram for explaining a notification of a context change;

FIG. 10 is an explanatory diagram illustrating an output of a reported event;

FIG. 11 is an explanatory diagram illustrating a specific example, of relationship formation;

FIG. 12 is an explanatory diagram illustrating a specific example of an event notification between virtual selves that have a relationship formed;

FIG. 13 is an explanatory diagram illustrating an example case where a user side pulls information relating to a supply from a provider side;

FIG. 14 is an explanatory diagram illustrating an example case where a provider side pushes supply-related information;

FIG. 15 is an explanatory diagram illustrating an example case where a provider side pulls information relating to a demand of a user side;

FIG. 16 is an explanatory diagram illustrating an example case where a user side pushes demand-related information;

FIG. 17 is an explanatory diagram illustrating an example case where the request transmission side designates a desired response time to the reception side; and

FIG. 18 is a block diagram illustrating an example of a computer that executes an information control program.

### DESCRIPTION OF EMBODIMENTS

By a conventional technology, information exchange is limited to information existing in the same time and space, and information that matches a user is not obtained from among many and unspecified pieces of information. Furthermore, if persons who have exchanged information become farther apart in terms of distance, it is not possible for the persons to exchange deeply-associated information that will be generated in the future.

One aspect aims to provide an information control program, an information control method, and an information control device that enable the followings not only in the past and present but also in the future: finding out, from among unknown and unspecified many people, persons who have a demand-supply relationship, an acquaintance relationship, or commonality in interests and concerns, and allowing the persons having association with one another to quickly exchange useful information with one another.

According to one embodiment, in a case where a demand-supply relationship is formed in the present or the future, or where commonality is found in interests and concerns, it is possible to establish a communicable relationship even between unknown and unspecified persons, without causing anyone trouble. Paradoxically, useless communication between persons who are not interested in each other can be reduced. As a communicable state has been established beforehand between persons having a high degree of association with each other, a state and a change in the state around each of the persons can be promptly reported as needed. Further, when finding association from exchanged profiles, a user can change the granularity of important attributes and concepts. Thus, a person can adjust the criteria for determining association between agents.

Hereinafter, an information control program, an information control method, and an information control device according to embodiments will be described with reference to the accompanying drawings. The components with like functions in the embodiments are denoted by like reference numerals, and will not be repeatedly explained. Note that the information control program, the information control method, and the information control device described in the following embodiments are merely examples, and do not limit embodiments. Further, the respective embodiments described below may be combined as appropriate, as long as there are no contradictions.

In this embodiment, information processing not to be handled by a person is left to software (an agent) serving as a virtual self of the target person, and the agent providing information matching the target person is interpreted as information control. Note that an agent will be sometimes referred to as a “virtual self” in the description below. Further, a target person having a virtual self may be in the position of a user who uses services, goods, and skills to be provided, or may be in the position of a provider who provides services, goods, and skills to users. The reason why the term “target persons” is used herein is that a “virtual self” profiles the features of an “individual” such as a person, an item, and a service, and serves as a virtual self (an agent) of the “individual” in processing information. In this embodiment, a target person is the employer (client) of a virtual self.

An information control device that serves as an agent that is a virtual self of a user in performing processing may be a processor existing in reality, such as a smartphone, a tablet terminal, or a personal computer (PC) owned by the user, for example, or may be a processor in a data center or in an edge router in edge computing.

Note that, in the example cases to be described in this embodiment, terminal devices such as smartphones possessed by respective users are used as information control devices that serve as agents in performing processing. However, examples of application of information control devices are not limited to terminal devices possessed by the respective users, as described above. For example, information control devices may also be any appropriate devices in a system, such as nodes in a network or servers in a data center. In an example, in a system configuration in which terminal devices (clients) to be used directly by users are separate from a server device, the server device may provide a function as an information control device. In such a system configuration, the server device functioning as an information control device serves as an agent in performing processing, and outputs information to be provided to the users to the terminal devices.

In this embodiment, the client (employer) of an information control device that serves as an agent in performing processing may be both a user who is provided with services, skills, and information, and a provider who provides services, skills, and information. In the description below, for each purpose that changes from moment to moment, the target person who uses a supplied item is called a user, and the target person who provides a service is called a provider. Further, in a case where no distinction is made between users, the term “user (provider)” is used.

In this embodiment, a profile indicating the features of the user (provider) is set beforehand in each agent. Each agent then performs profile exchange, to exchange set profiles with one or a plurality of other agents.

Each agent that has performed the profile exchange compares the profile of another agent acquired through the profile exchange with its own profile, and determines whether these agents are the agents of users (providers) having association (commonality) with each other's features. On the basis of the results of this evaluation, each agent acquires an access method from the other agent having association (commonality), and establishes a relationship in which the agents having association (commonality) can communicate with each other.

Each agent then notifies the other agent having a relationship established of an event based on a context indicating the state of the user (provider), such as a change in the context, for example.

The context indicating the state of the user (provider) is dynamic, changes in a short period of time. The context is divided into an external context and an internal context, for example. An example of the external context is an environment surrounding the user (provider), and changes regardless of the intention of the user. The external context may be temperature, humidity, weather, season, and the like, for example. The external context also includes the location of the user (provider), the current time, and the state of the user (provider) (during working hours, driving a car, remaining business hours until closing, or the like), for example. Further, changes in the external context include not only the occurrence of an emergency, such as the occurrence of a disaster, an accident, or an incident, but also an input of data or information to the user (provider).

Meanwhile, an example of the internal context indicates the physical condition and the emotion of the target person. The internal context includes information relating to physical conditions, such as whether the user (provider) is tired or energetic, or is sick or healthy, for example. The internal context also includes information relating to emotions, such as whether the user (provider) is in a good mood or is depressed, or wants to go home early or wants to act more, for example.

Each agent acquires a context indicating the state of the user (provider). For example, each agent acquires an external context from the results of detection performed by a sensor or the like, or from the results of an inquiry to a weather site or the like. Each agent also acquires an internal context from the contents of the user's (provider's) posting to a social networking service (SNS), an interview survey with the user (provider), the web service usage status (search words used on search sites) of the user (provider), or the like, for example.

When there is a change in the acquired context, each agent then notifies an agent having a relationship established of the contents of the changed context as an event. The agent notified of the event outputs the reported event to a display or the like, and notifies the user (provider) of the event.

For example, in a case where there is a change in the environment (temperature, humidity, and weather) surrounding the user (provider), the state (during working hours, driving a car, remaining business hours until closing, or the like) of the user (provider), the physical condition (illness, health condition, or the like), and the emotional state (in good mood, depressed, or the like), each agent issues a notification of the changed context as an event. Data inputs that affect users (providers) are also handled as events. The notified agent outputs the contents of the event (a change in the state of the user (provider) of the agent that has issued the event notification) to a display or the like, if needed.

In this manner, each agent constructs a relationship that enables communication between agents having association (commonality) with each other's features by exchanging profiles. Each agent then notifies the other agent having a relationship established of an event based on the state (context) of the user (provider). In a case where there is a notification of an event from another agent having a relationship established, each agent also outputs the reported event. Thus, the user (provider) of an agent may establish a relationship in which the user (provider) can communicate even with an unspecified and unknown person who has a demand-supply relationship, has commonality in interests and concerns, or has a possibility that the relationship or the commonality/association becomes stronger not only in the past and the present but also in the future. Dynamic states and changes in the states around the respective persons can be promptly reported to, each other. Not only between known persons but also between unspecified and unknown persons, it is possible to find useful services, skills, and information, without bothering the target person. Further, event notifications are transmitted only to persons having association with each other. Thus, it is possible to reduce communication traffic between persons not interested in each other.

[Configuration of an Information Control Device]

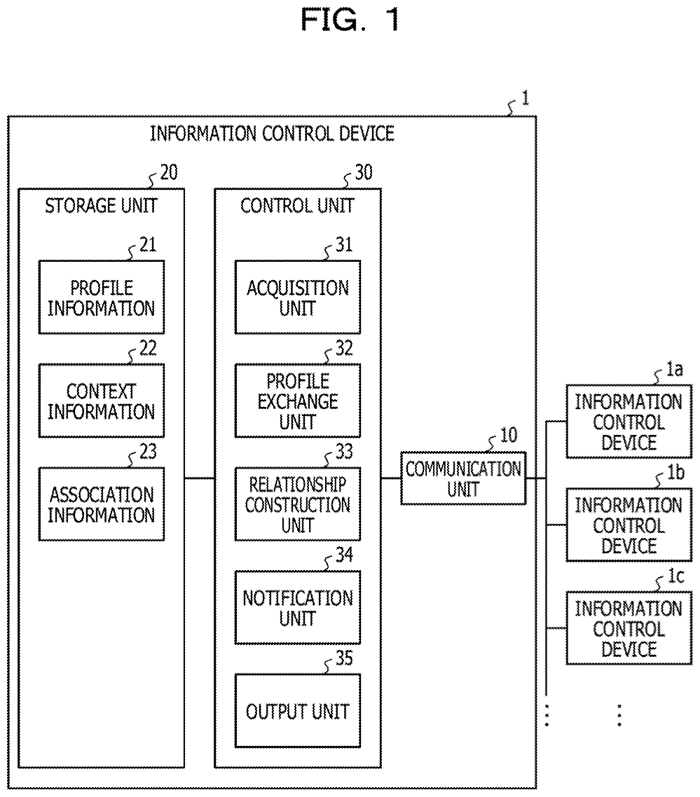

FIG. 1 is a block diagram illustrating an example functional configuration of an information control device according to an embodiment. As illustrated in FIG. 1, an information control device 1 is an example of an information processing device that performs processing as an agent that is a virtual self of a user (a provider), and includes a communication unit 10, a storage unit 20, and a control unit 30.

The communication unit 10 controls communication with other computers and the like, such as information control devices 1a, 1b, 1c, and the like, regardless of whether wired or wireless. The communication unit 10 is a communication interface or the like, such as a network interface card (NIC), for example.

The storage unit 20 stores various kinds of data and the like, such as a program to be executed by the control unit 30, profile information 21, context information 22, and association information 23, for example. The storage unit 20 is equivalent to a semiconductor memory element such as a random access memory (RAM), a read only memory (ROM), or a flash memory, or a storage device such as a hard disk drive (HDD).

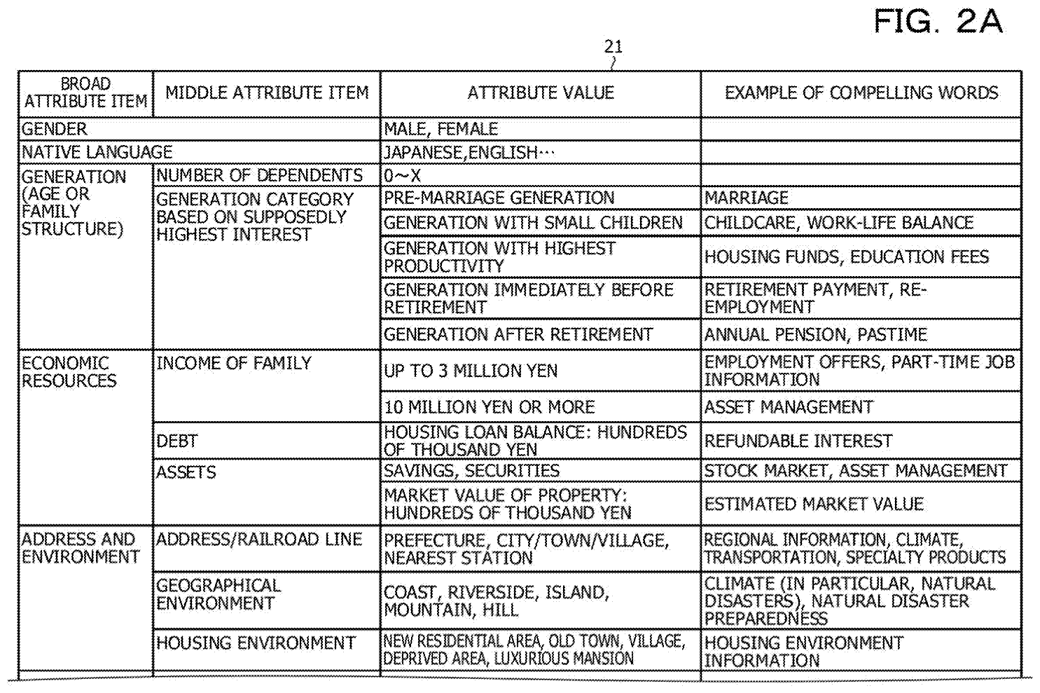

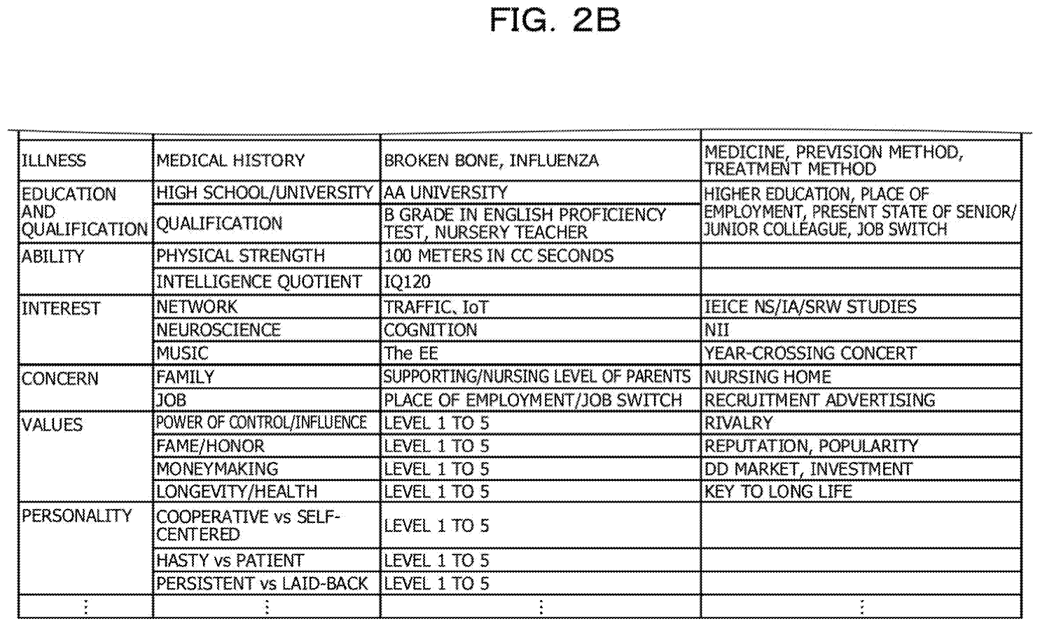

The profile information 21 is a data file or the like that stores a profile of a user (a provider) of the information control device 1. FIGS. 2A and 2B are explanatory diagrams illustrating an example of the profile information 21.

As illustrated in FIGS. 2A and 2B, the profile information 21 indicates the features of a user (a provider) with the respective attribute values for a wide variety of attributes such as gender, native language, generation, and address/environment. The attribute value of each attribute in the profile information 21 is written as at least one of the following items: a common noun, a proper noun, a numerical value, and a logic.

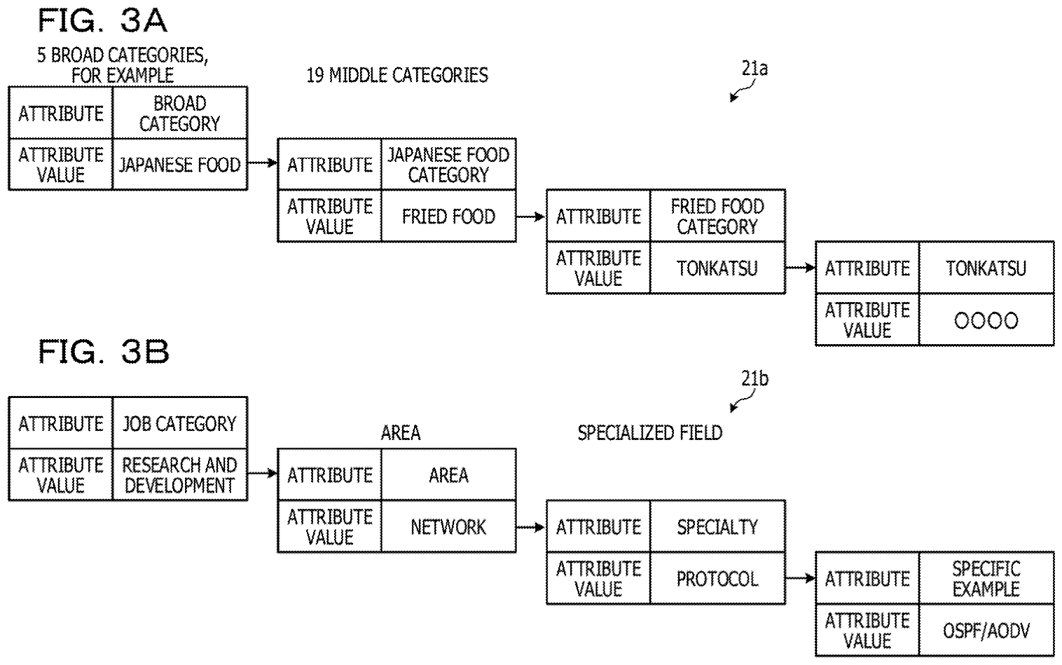

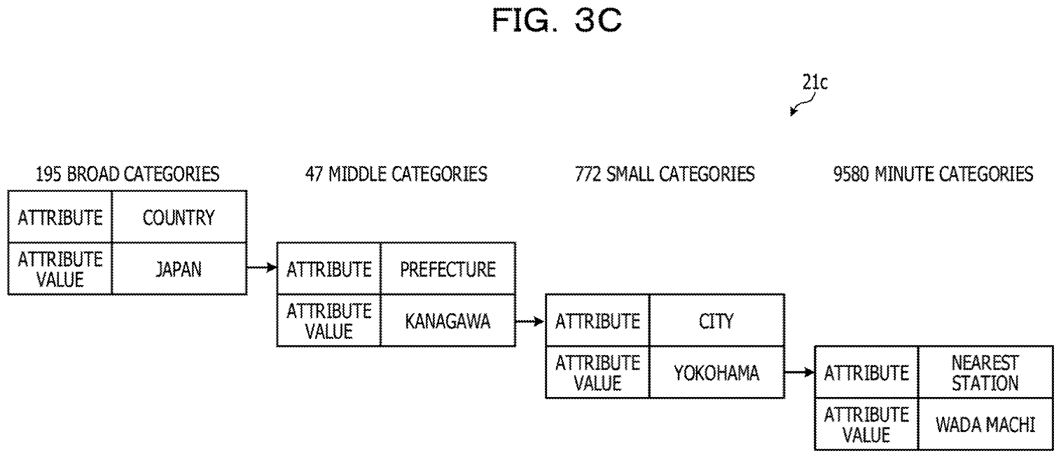

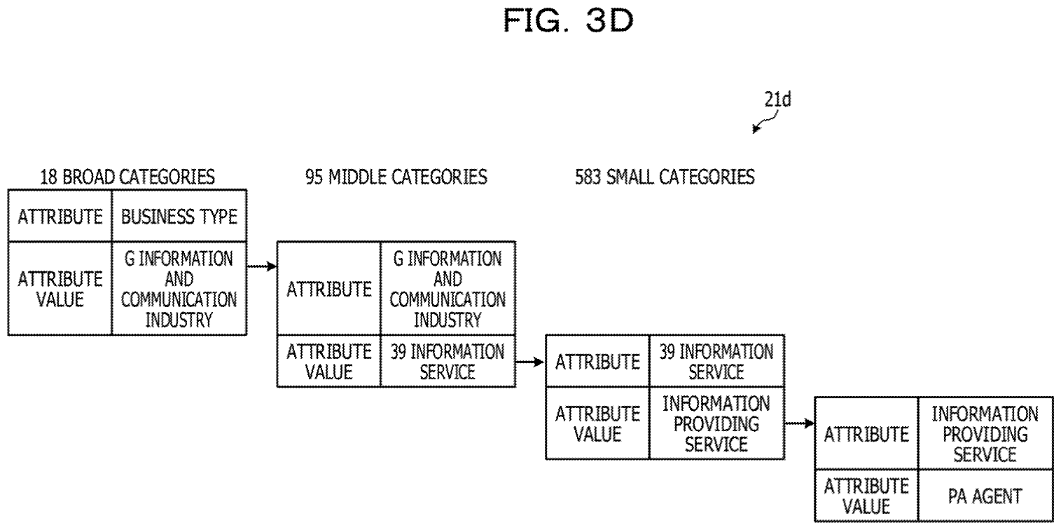

Further, each attribute in the profile information 21 has a hierarchical structure including lower-level attributes (intermediate attribute items in the drawing) under higher-level attributes (greater, attribute items in the drawing). FIGS. 3-1 through 3-4 are explanatory diagrams each illustrating an example of the hierarchical structure of a profile. For example, as illustrated in FIG. 3A, profile information 21a about the food that the user (provider) is interested in has a hierarchical structure such as following: broad category->Japanese food category->fried food category->tonkatsu (the name of the restaurant that serves the food). Further, in the profile information 21a, attribute values, such as “Japanese food” in the broad category->“fried food” in the Japanese food category->“tonkatsu” in the fried food category->“OOOO” such as the restaurant that serves “tonkatsu”, are set in the attributes at the respective hierarchical levels. What is to be noted here is which hierarchical level attention is to be paid to in evaluating commonality varies with purposes of use. For example, when hosting guests from other countries, and the host looks for a restaurant having “Japanese food” as the attribute value, those who like tonkatsu look for a restaurant having “tonkatsu” as the attribute value. Therefore, the depth of the hierarchy of interest is preferably adjusted as described later (FIGS. 8-1 and 8-2).

Also, as illustrated in FIG. 36, profile information 21b about the category of the job of the user (provider) has a hierarchical structure such as follows: job category->area->specialized field->specific example. Further, in the profile information 21b, attribute values, such as “research and development” in the job category->“network” as the area->“protocol” as the specialty->“OSPF/AODV” as a specific example, are set in the attributes at the respective hierarchical levels. Which hierarchical level attention is to be paid to in evaluating commonality varies with purposes of use, as in the example described above. When recruiting new specialists, candidates may be recruited for the broader specialty attribute “network” in some cases and experts may be recruited for the attribute value “protocol” or even more specific attribute value “routing protocol such as OSPF” in other cases. Therefore, the depth of the hierarchy of interest is preferably adjusted as described later (FIGS. 8-1 and 8-2).

As illustrated in FIG. 3C, profile information 21c about the address of the user (provider) has a hierarchical structure such as follows: country->prefecture->city->nearest station. Further, in the profile information 21c, attribute values, such as “Japan” as the country->“Kanagawa” as the prefecture->“Yokohama” as the city->“Wadamachi” as the nearest station are set in the attributes at the respective hierarchical levels.

As illustrated in FIG. 3D, profile information 21d about the type of business of the user (provider) has a hierarchical structure such as follows: business type->G information and communication industry->39 information service->information providing service. Further, in the profile information 21d, attribute values, such as “G information and communication industry” as the business type->“39 information service” of the G information and communication industry->“information providing service” of the 39 information service->“PA agent” of the information providing service, are set in the attributes at the respective hierarchical levels.

As described above, in the profile information 21a, 21b, 21c, and 21d, each lower-level attribute (for example, the Japanese food category) has a structure in which the attribute value of the higher-level attribute (for example, a broad category) is specified.

Returning back to FIG. 1, the context information 22 is a data file or the like indicating a status (context) relating to the user (provider) of the information control device 1. For example, the context information 22 stores, in text format, the environment (temperature, humidity, and weather) surrounding the user (provider), the state (during working hours, driving a car, remaining business hours until closing, or the like) of the user (provider), the physical condition (illness, health condition, or the like), the emotional state (in good mood, depressed, or the like), and the like.

The association information 23 is data file or the like indicating the agents of the other ends (associates) with which a relationships has been established. For example, the association information 23 stores, in text format, the network addresses, the access methods, and the like of the information control devices 1a, 1b, 1c, and the like related to the agents which a relationship has been established.

The control unit 30 is a processing unit that controls the overall processing to be performed by the information control device 1. The control unit 30 is formed with a central processing unit (CPU), a micro processing unit (MPU), or the like executing a program stored in an internal storage device using the RAM as a work area, for example. Alternatively, the control unit 30 may be formed with an integrated circuit such as an application specific integrated circuit (ASIC) or a field programmable gate array (FPGA), for example.

The control unit 30 includes an acquisition unit 31, a profile exchange unit 32, a relationship construction unit 33, a notification unit 34, and an output unit 35. Note that the acquisition unit 31, the profile exchange unit 32, the relationship construction unit 33, the notification unit 34, and the output unit 35 are an example of an electronic circuit included in a processor and an example of a process to be executed by the processor.

The acquisition unit 31 is a processing unit that acquires a profile and a context relating to the user (provider) of the information control device 1.

Specifically, the acquisition unit 31 receives an information input (an input of the attribute values of the respective attributes, for example) relating to the profile of the user (provider) via a graphical user interface (GUI) or the like. The acquisition unit 31 then turns the input attribute values of the respective attributes into a hierarchical structure based on the information input relating to the profile, and stores the hierarchical structure as the profile information 21 into the storage unit 20. In other words, the acquisition unit 31 is an example of a generation unit that generates the profile information 21.

Note that, when information about a profile is input through a GUI or the like, the acquisition unit 31 may acquire the profile information 21 as a template from another information control device 1a, 1b, 1c, or the like, and receive an input of the attribute values of the respective attributes based on the acquired profile information 21, For example, the acquisition unit 31 acquires the profile information 21c (see FIG. 3c) indicating the address of the user (provider) as a template from another information control device 1a, 1b, 1c or the like. The acquisition unit 31 then receives an input of attribute values in the order of, for example, country->prefecture->city->nearest station, in, accordance with the hierarchical structure of the acquired profile information 21c, Thus, the information control device 1 can easily create the profile information 21 having the same hierarchical structure as in other information control devices 1a, 1b, and 1c.

The acquisition unit 31 also acquires the state (during working hours, driving a car, remaining business hours until closing, or the like) and the physical condition (illness, health condition, or the like) of the user (provider), from the results of detection performed by a sensor (not illustrated) or the like. The acquisition unit 31 also acquires the environment (temperature, humidity, and weather) surrounding the user (provider), from the results of an inquiry make to a weather site or the like. The acquisition unit 31 further acquires the state and the emotion (in good mood, depressed, or the like) of the user (provider), from the contents of the user's (provider's) post on an SNS, an interview with the user (provider), the Web service usage status of the user (provider), and the like. The acquisition unit 31 then stores the acquired contexts as the context information 22 into the storage unit 20.

The profile exchange unit 32 is a processing unit that exchanges profiles to notify the agent(s) of one or a plurality of the information control devices 1a, 1b, 1c, and the like, of the profile information 21.

Specifically, the profile exchange unit 32 issues a profile exchange request to many and unspecified information control devices 1a, 1b, 1c, and the like, using a broadcast or multicast function of a lower layer protocol, for example, via the communication unit 10. The profile exchange unit 32 then establishes communication with the information control devices 1a, 1b, 1c, and the like that have responded to the request, and notifies the information control devices 1a, 1b, 1c, and the like of the profile information 21 read from the storage unit 20. The profile exchange unit 32 also acquires profile information from the other party (the information control devices 1a, 1b, 1c, and the like) with which communication has been established. The profile exchange by the profile exchange unit 32 may be performed at any appropriate time preset by the user (provider) in a memory or the like, or may be performed at predetermined intervals (once a week, for example) that are set in advance.

The relationship construction unit 33 is a processing unit that constructs a relationship with one or a plurality of agents having a profile related to the user (provider) of the information control device 1 among the agents of the information control devices 1a, 1b, 1c, and the like, in accordance with the profile information acquired by the profile exchange unit 32.

Specifically, the relationship construction unit 33 compares the profile, of another agent acquired through the profile exchange with its own profile in the profile information 21, As a result of this comparison, the relationship construction unit 33 determines whether the agent of the user (provider) and the agent of the other agent have association (commonality) to each other's features. On the basis of the evaluation results, the relationship construction unit 33 constructs a relationship that enables communication with another agent having association (commonality).

For example, prior to relationship construction, the relationship construction unit 33 confirms the construction of the relationship with the user (provider) using a GUI or the like. If a confirmation is obtained, the relationship construction unit 33 issues an access right request (an access method request) to the agent (the information control device 1a, 1b, 1c, or the like) for which a relationship is to be constructed. The relationship construction unit 33 then acquires an access method as a response to the access right request, and stores the acquired access method as the association information 23, together with the information about the address of the other side, into the storage unit 20.

Note that, in a case where a relationship construction request has been received, the relationship construction unit 33 receives an access right request (an access method request) from the agent (the information control device 1a, 1b, 1c, or the like) on the other side. Using a GUI or the like, the relationship construction unit 33 then requests the user (provider) of the information control device 1 to grant an access right for enabling communication with another agent in a case where an access right is granted, the relationship construction unit 33 notifies the agent (the information control device 1a, 1b, 1c, or the like) on the other side from which the access right request has been issued, of the access method.

The notification unit 34 is a processing unit that issues an event notification based on the context information 22 indicating the state of the user (provider) to another agent (the information control device 1a, 1b, 1c, or the like) for which a relationship has been constructed.

Specifically, the notification unit 34 sequentially reads the context information 22 from the storage unit 20, and checks an alteration (a change) in the contents (context). In a case where there is a change in the context, the notification unit 34 obtains the contents of the context after the change as an event. The notification unit 34 then notifies the other agent (the information control device 1a, 1b, 1c, or the like) of the obtained event, in accordance with the address information and the access method indicated in the association information 23.

Note that the notification unit 34 may set conditions for a change in a context notified as an event. Specifically, in a case where a change in a context satisfies a condition (a condition for an event to actively issue a notification, for example) that has been set beforehand by the user (provider), the notification unit 34 notifies another agent (the information control device 1a, 1b, 1c, or the like) of the change as an event. Note that, if the condition is not satisfied, the notification unit 34 discards the change in a context, without repotting the change as an event.

In an example case where a change in a context relating to the current position of the user (provider) is set beforehand as a condition for issuing a notification, the notification unit 34 notifies another agent of an event indicating a change in the current position of the user (provider).

The output unit 35 is a processing unit that outputs a reported event in a case where there is an event notification from another agent (the information control device 1a, 1b, 1c, or the like) for which a relationship has been constructed. Specifically, the output unit 35 outputs the contents of an event reported from another agent to a display (not illustrated), and notifies the user (provider) of the information control device 1 of the contents of the event.

Note that the output unit 35 may set conditions for an event to be output. Specifically, in a case where a reported event satisfies a condition (a condition for an event to actively make an output, for example) that has been set beforehand by the user (provider) and the like, the output unit 35 outputs the reported event to a display or the like. Note that, if the condition is not satisfied, the output unit 35 discards the notification of the event, without outputting the event to a display or the like.

In an example case where an event relating to the current position of the user (provider) is set beforehand as a condition for making an output, the notification unit 34 outputs a reported event relating to the current position of the user (provider).

[Processing Flow]

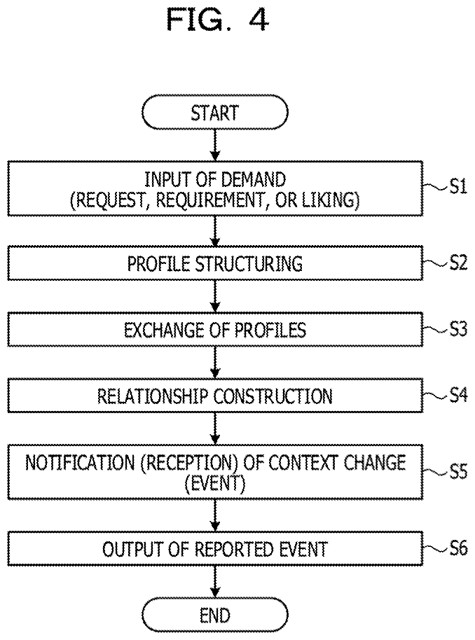

FIG. 4 is a flowchart illustrating an example operation of the information control device 1 according to the embodiment. As illustrated in FIG. 4, when a process is started, the acquisition unit 31 receives an input of information (a demand (request/requirement/liking), a supply (supply spec cation/providing skill), or the like) regarding a profile (S1). The acquisition unit 31 then turns the attribute values of the respective attributes input as the information into a hierarchical structure (profile structuring), and stores the hierarchical structure as the profile information 21 into the storage unit 20 (S2).

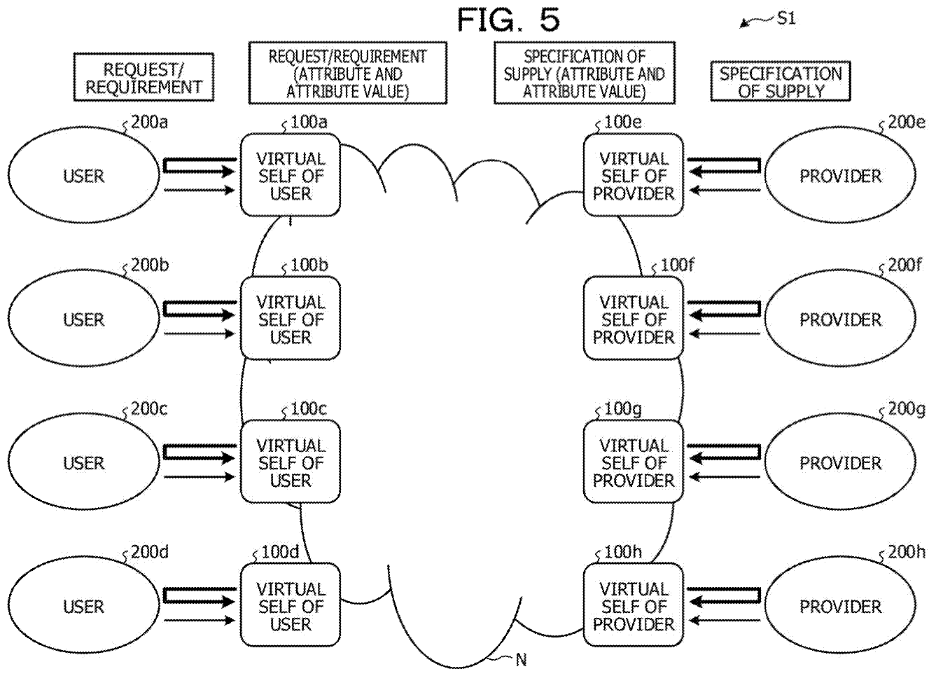

FIG. 5 is an explanatory diagram illustrating inputs of demands (requests/requirements/likings) or supplies (supply specifications/providing skills) to virtual selves. The target person (a user or a provider, or a designer entrusted by the user or the provider) may send a push notification to an agent, or an agent may automatically observe and pull outputs from users and providers. An agent may also present a screen indicating attributes, to prompt a user or a provider to input attribute values, and thus generate a profile. At this stage, there is also a method by which attribute value candidates are displayed in a pull-down menu or in a radio button format, and a user or a provider simply selects attribute values to enter the attribute values for the attributes. In FIG. 5, agents 100a through 100d are virtual selves of users 200a through 200d. The virtual selves are provided by the information control devices 1 possessed by the users 200a through 200d. Likewise, agents 100e through 100h are virtual selves of providers 200e through 200h. The virtual selves are provided by the information control devices 1 possessed by the providers 200e through 200h. Further, the agents 100a through 100h are communicably connected to one another via a network N such as the Internet.

Note that, in a case where the agents 100a through 100h are not specifically distinguished from one another, the agents 100a through 100h are referred to as the agents 100. Likewise, in a case where the users 200a through 200d and the providers 200e through 200h are not specifically distinguished from one another, the users 200a through 200d and the providers 200e through 200h are referred to as the users (providers) 200.

As illustrated in FIG. 5, in S1, each of the users 200a through 200d on the demander side who are to be supplied with services or the information issues a request or inputs the features (attributes and attribute values) of the service or the information of interest. As a result, profiles (the profile information 21) relating to the requests/requirements for services and information on the demander side are set in the agents 100a through 100d.

Likewise, in S1, each of the providers 200e through 200h on the supplier side that provides information inputs features (attributes and attribute values) relating to services, information, and skills that can be provided. As a result, profiles (the profile information 21) relating to supplies such as services, skills, and information on the supplier side are set in the agents 100e through 100h.

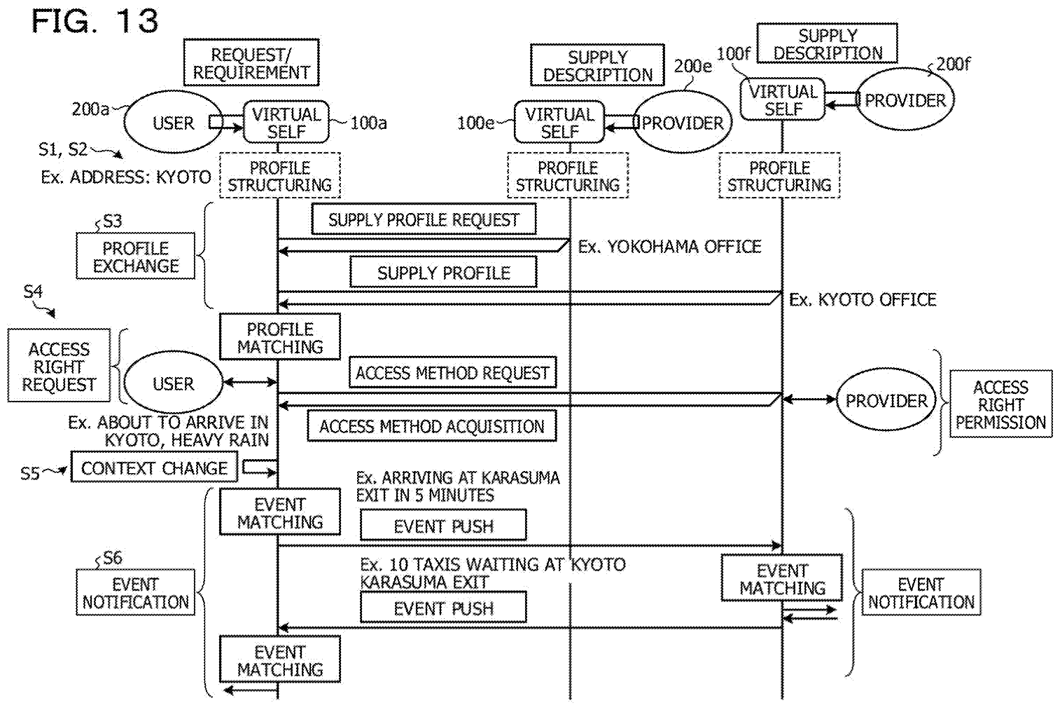

The profile exchange unit 32 then exchanges profiles 21 between the users and the providers via the network N. At this stage, as will be described later (FIGS. 13 through 16), the information control devices of the other party may be selected one by one, or a broadcast or multicast function is used so that the profile information 21 is collectively exchanged with the agent(s) 100 of one or a plurality of the information control devices 1a, 1b, 1c, and the like connected via the network N. Thus, profile exchanges are performed (S3).

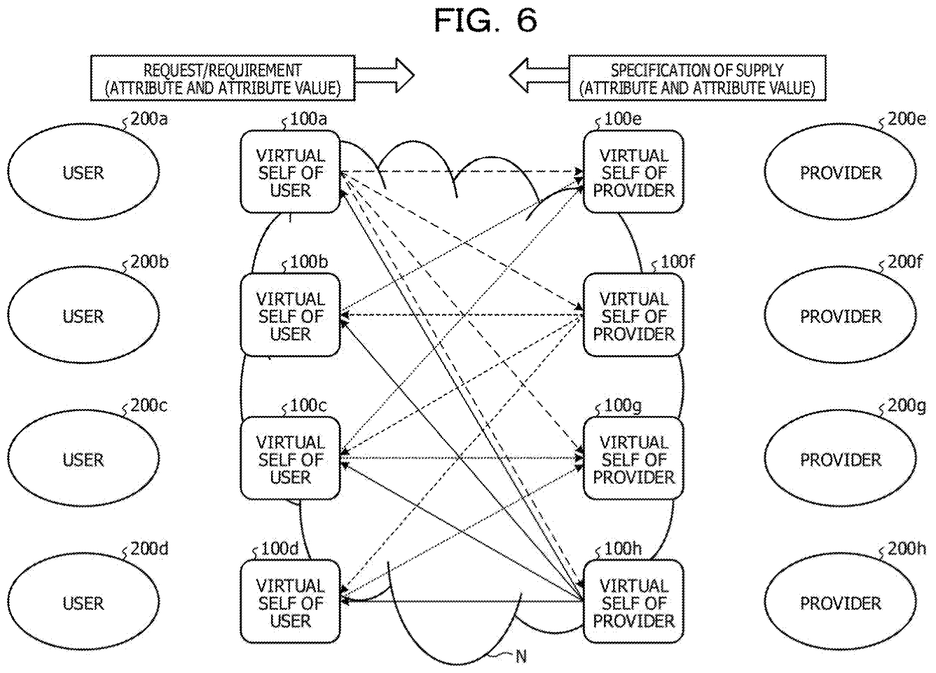

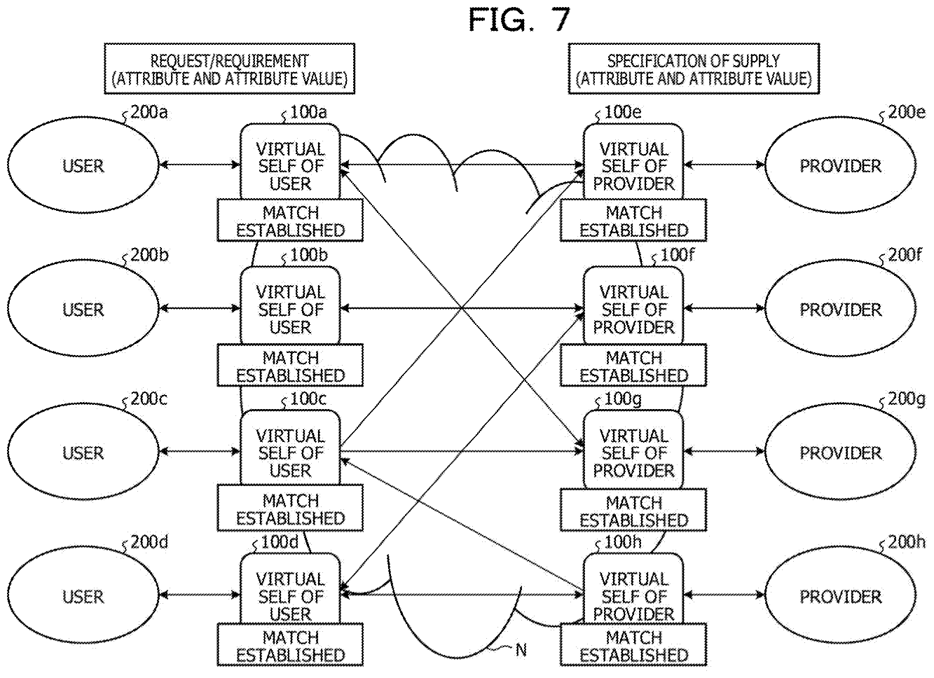

FIG. 6 is an explanatory diagram illustrating exchanges of profiles. As illustrated in FIG. 6, in S3, the agents 100a through 100d of the users 200a through 200d notify the agents 100e through 100h of the providers 200e through 200h, respectively, of the profile information 21 indicating features such as request/requirements, via the network N, for example. Likewise, the agents 100e through 100h of the providers 200e through 200h notify the agents 100a through 100d of the users 200a through 200d, respectively, of the profile information 21 indicating features such as supply specifications, via the network N.

The relationship construction unit 33 then constructs a relationship with one or a plurality of agents 100 having a profile related to the user (provider) 200 of the information control device 1 among the agents 100 of the information control devices 1a, 1b, 1c, and the like, in accordance with the acquired profile information 21 (S4).

FIG. 7 is an explanatory diagram for explaining relationship construction. As illustrated in FIG. 7, in S4, the agents 100a through 100d compare the profile information 21 about the agents 100e through 100h acquired through profile exchanges with the profile information 21 about the agents 100a through 100d. Likewise, the agents 100e through 100h compare the profile information 21 about the agents 100a through 100d acquired through profile exchanges with the profile information 21 about the agent 100e through 100h. As a result of this comparison, the agents 100a through 100h determine whether the agents 100a through 100h are the agents 100 of users (providers) 200 having association (commonality), such as a demand-supply relationship, a master-disciple (supervisor-subordinate) relationship, or an acquaintance relationship involving common interest/concerns, in each target person's profile. By doing so, the agents 100a through 100h determine whether a match is established. The agents 100a through 100h then request the agents 100 that have succeeded in matching to construct a relationship, and acquire an access method and the like, to establish a relationship that can be communicated.

For example, in the example illustrated in the drawing, as for the agent 100a, a match is established after the agents 100e and 100g are determined to have association (commonality) with the agent 100. Accordingly, the agent 100a constructs a relationship with each of the agents 100e and 100g.

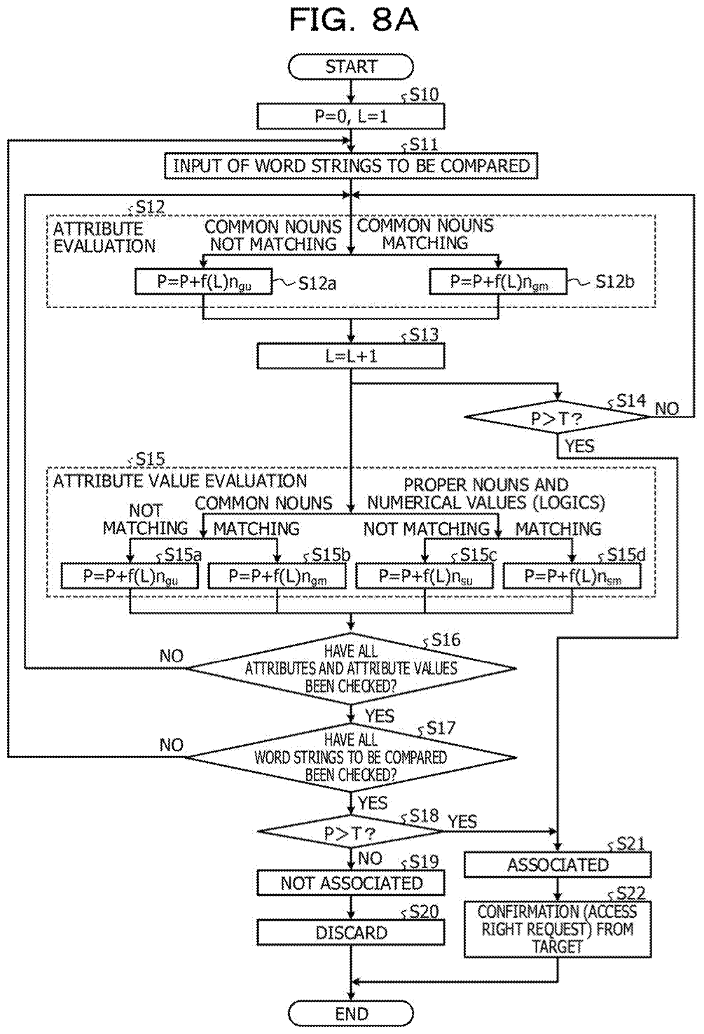

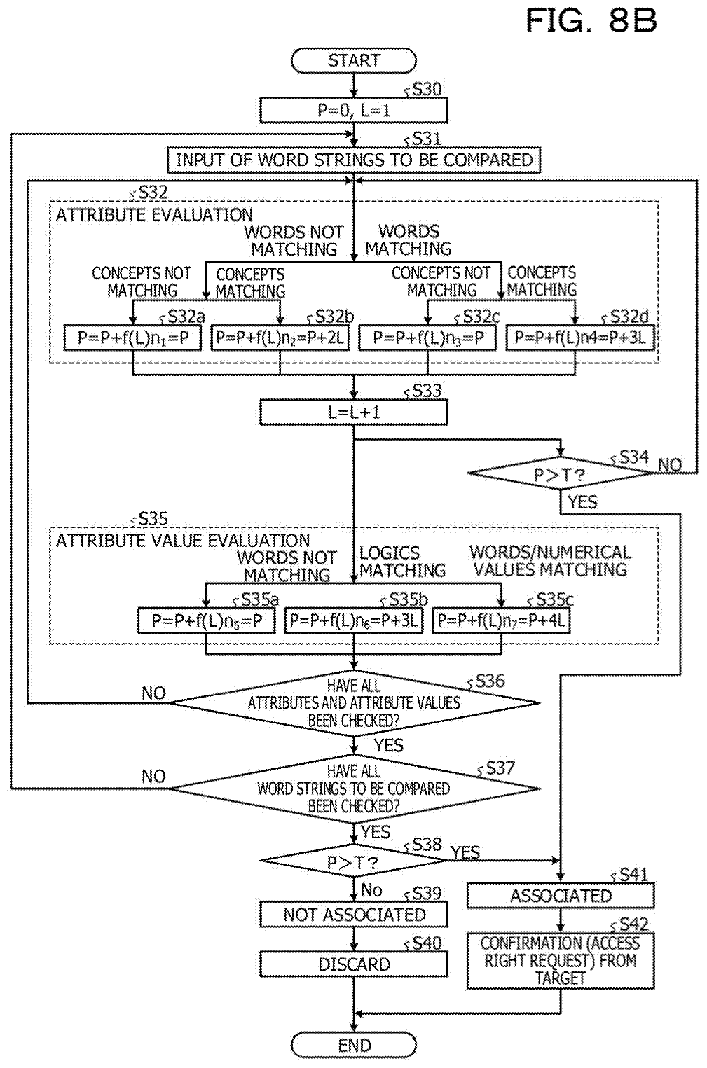

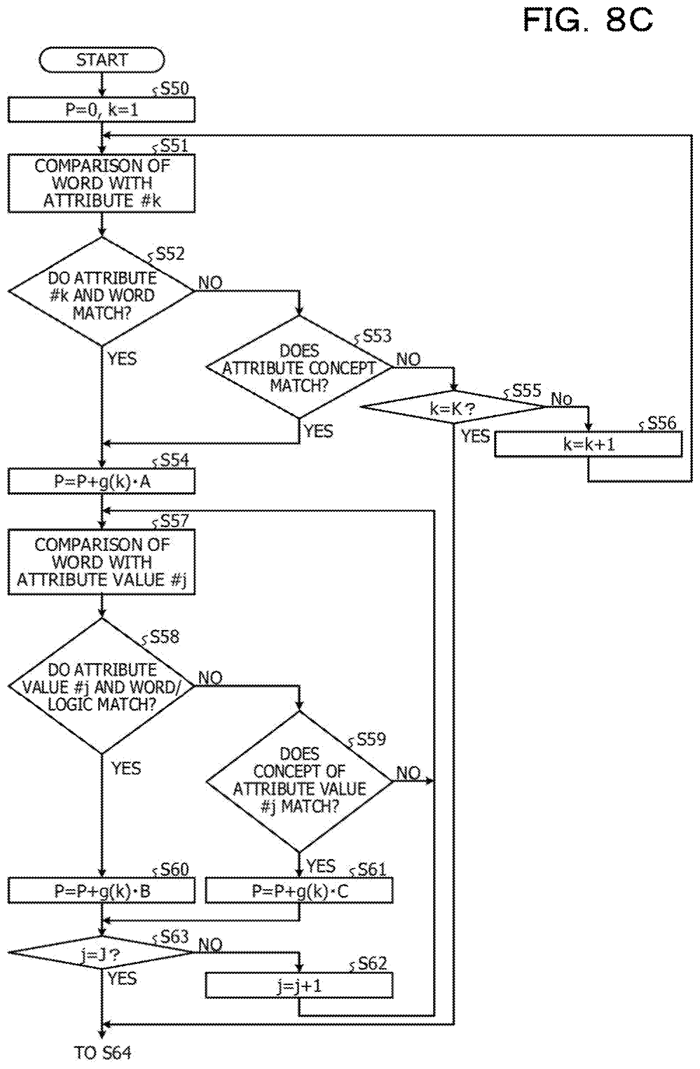

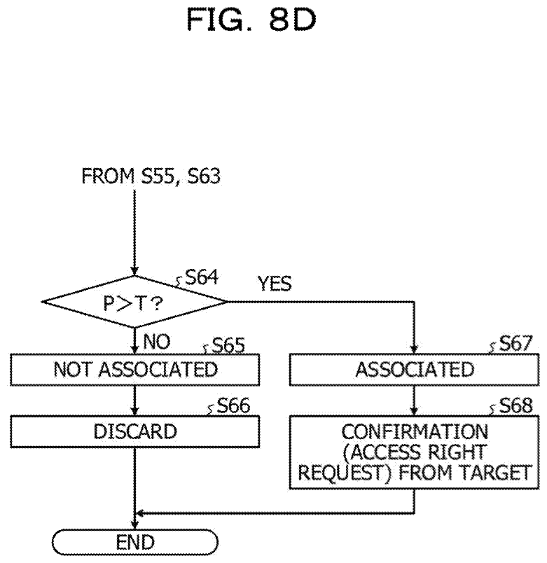

Example processes relating to relationship construction are now described in detail. It is desirable that a person (target person) such as a user or a provider can adjust which word appearing in a profile is emphasized to determine whether there is a relationship. Here, a plurality of evaluation axes exists in terms of which word is emphasized when a person checks words for a match/mismatch. In view of this, FIGS. 8-1 through 8-3 illustrate flowcharts illustrating example relationship construction processes. All of the example processes are based on evaluating the commonality of words (languages) appearing in user/provider profiles, but are characterized in that the weighting method can be adjusted by users/providers. The example processes illustrated in FIGS. 8-1 and 8-2 are methods for enabling adjustment of the depth of a hierarchy of interest as described above with reference to FIGS. 3-1 through 3-4, n a case where the attribute and attribute values in a profile form a hierarchical structure. The example process illustrated in FIGS. 8C and 8D is a method for enabling adjustment of the attribute of interest, in case where a profile is written in a plurality of combinations of attributes and attribute values.

First, a first example process relating to relationship construction is described. As illustrated in FIG. 8A, when the process is started, the relationship construction, unit 33 initializes variables (P=0, L=1) and the like to be used in the process (S10). Here, P represents an evaluation value (a total score) indicating the degree of association when comparing the profile information 21, and the initial value of P is 0. Meanwhile, L represents a value indicating the depth (increased from 1, according to the depth) in the hierarchical structure of the profile information 21 for the attribute of the item to be processed, and the initial value of L is 1.

The relationship construction unit 33 then receives an input of word strings to be compared at the hierarchical level of the depth (L) in the sets of the profile, information 21 to be compared with each other (S11). By doing so, the relationship construction unit 33 obtains the attribute values (word strings) of the same hierarchical level from the respective sets of the profile information 21 to be compared.

The relationship construction unit 33 compares the word strings input from the sets of the profile information 21 to be compared with each other, and performs attribute evaluation to determine an evaluation value (P) (S12). Specifically, the relationship construction unit 33 determines whether the word strings match each other in the common nouns. If the word strings do not match, the relationship construction unit 33 determines the evaluation value to be P=P+f(L)n_{gu} (S12a). If the common nouns match, on the other hand, the relationship construction unit 33 determines the evaluation value to be P=P+f(L)n_{gm} (S12b).

Here, f(L) is a function depending on the depth (L) in the hierarchical structure of the attribute, and f(L)=X\hat{ }L, for example. If importance, is placed on word matching at a deep hierarchical level, a higher score is given to matching words, where X>1.0, and L has a greater value. conversely, if importance is placed on broadness, the weight on matching words is greater, where X<1.0, and L is smaller. Meanwhile, n_{gu} and n_{gm} are evaluation scores depending on the match/mismatch between the common nouns. The evaluation scores depending on the match/mismatch between the common nouns are set by the user (provider) 200 or the like, as appropriate. For example, 0 is set to n_{gu}, and 2 is set to n_{gm}, so that the added score is large only when they match.

The relationship construction unit 33 then increments L to be L=L+1 (S13), and determines whether the evaluation score (P) exceeds a predetermined threshold (T) (P>T?) (S14). The threshold (T) is a value that has been set beforehand as a criterion for determining relevancy (commonality) by the user (provider) 200 or the like.

If the evaluation score (P) exceeds the predetermined threshold (T) (S14: Yes), the relationship construction unit 33 moves on to S21. If the evaluation score (P) does not exceed the predetermined threshold (T) (S14: No), the relationship construction unit 33 returns to S12.

After S13, the relationship construction unit 33 also, performs attribute value evaluation by comparing word strings input from the sets of the profile, information 21 to be compared with each other (S15). Specifically, the relationship construction unit 33 performs character analysis on the respective word strings, and determines whether the word strings are common nouns, proper nouns, or numerical values (logics).

In the case of common nouns, the relationship construction unit 33 determines whether the word strings match each other in the common nouns. If the word strings do not match, the relationship construction unit 33 determines the evaluation value to be P=P+f(L)n_{gu} (S15a). If the common nouns match, on the other hand, the relationship construction unit 33 determines the evaluation value to be P=P+f(L)n_{gm} (S15b). Further, in the case of proper nouns/numerical values (logics), the relationship construction unit 33 determines whether the word strings match each other in the proper nouns/numerical values (logics). If the word strings do not match, the relationship construction unit 33 determines the evaluation value to be P=P+f(L)nₛᵤ (S15c). If the proper nouns/numerical values (logics) match, the relationship construction unit 33 also determines the evaluation value to be P=P+f(L)nₛₘ (S15d).

Here, nₛᵤ and nₛₘ represent evaluation scores depending on the proper nouns/numerical values (logics). The evaluation scores depending on the proper nouns/numerical values (logics) are set by a user (provider) 200 or the like, as appropriate. For example, 0 is set to nₛᵤ, and 3 is set to nₛₘ, so that any score is not, added in the case of a mismatch, and a higher score (n_{gm}<nₛₘ) is added to matching proper nouns/numerical values than matching common nouns. Thus, importance can be placed on matching proper nouns/numerical values (logics) being evaluated.

After S15, the relationship construction unit 33 determines whether all the attributes and attribute values in the sets of the profile information 21 to be compared with each other have been checked (whether attribute evaluation and attribute value evaluation have been completed) (S16). If all the attributes and attribute values have been checked (S16: Yes), the relationship construction unit 33 moves on to S17. If not all the attributes and attribute values have been checked (S16: No), on the other hand, the relationship construction unit 33 returns to S12.

In S17, the relationship construction unit 33 determines whether all the word strings to be compared have been checked. If all the word strings to be compared have been checked (S17: Yes), the relationship construction unit 33 moves on to S18. If not all the word strings to be compared have been checked (S17: No), on the on the other hand, the relationship construction unit 33 returns to S11.

In S18, the relation hip construction unit 33 determines whether the evaluation score (P) exceeds the predetermined threshold (T) (P>T?). If the evaluation score (P) does not exceed the predetermined threshold (T) (S18: No), the relationship construction unit 33 determines that the agents 100 of the sets of the profile information 21 compared with each other have no association (commonality) or is “not associated” (S19). The relationship construction unit 33 then discards the information about the agent 100 determined to be “not associated”, without performing relationship construction (S20), and ends the process.

If the evaluation score (P) exceeds the predetermined threshold (T) (S18: Yes), the relationship construction unit 33 determines that the agents 100 of the sets of the profile information 21 compared with each other have association (commonality) or is “associated” (S21). The relationship construction unit 33 then performs confirmation (an access right request) from the target person (user (provider) 200) to the agents 100 determined to be “associated” (S22). The relationship construction unit 33 then performs relationship construction, and ends the process.

Next, a second example process relating to relationship construction is described. As illustrated in FIG. 8B, when the process is started, the relationship construction unit 33 initializes variables (P=0, L=1) and the like to be used in the process (S30), as in S10. The relationship construction unit 33 then receives an input of word strings to be compared at the hierarchical level of the depth (L) in the sets of the profile information 21 to be compared with each other (S31).

The relationship construction unit 33 then compares the word strings input from the sets of the profile information 21 to be compared with each other, determines whether the words and the concepts of the words match, and performs attribute evaluation to determine an evaluation value (P) (S32).

Specifically, the relationship construction unit 33 compares the words in the respective word strings, and determines whether the words match. If the words do not match, the relationship construction unit 33 determines whether the concepts of the words match. If the concepts do not match, the relationship construction unit 33 determines the evaluation value to be P=P+f(L)n₁ (S32a). If the concepts match, on the other hand, the relationship construction unit 33 determines the evaluation value to be P=P+f(L)n₂ (S32b).

Note that, in concept determination, dictionary data showing the meanings, concepts, and the like of respective words is referred to, and the concepts of the words are compared, to determine whether the concepts match.

Likewise, if the words match, the relationship construction unit 33 determines whether the concepts of the words match. If the concepts do not match, the relationship construction unit 33 determines the evaluation value to be P=P+f(L)n₃ (S32c). If the concepts match, on the other hand, the relationship construction unit 33 determines the evaluation value to be P=P+f(L)n₄ (S32d).

Here, n₁ and n₂ are evaluation scores depending on whether the concepts match in a case where words do not match. Further, n₃ and n₄ are evaluation scores depending on whether the concepts match in a case where words match. These evaluation scores are set by a user (provider) 200 or the like, as appropriate. For example, 0 is set to n₁ and 2 is set to n₂, so that evaluation scores can be given as long as concepts match even if words do not match. Further, 0 is set to n₃, and 3 is set to n₄, so that high evaluation is not made when the concepts do not match even though the words match, and the highest evaluation can be made when the words and the concepts both match.

The relationship construction unit 33 then increments L to be L=L+1 (S33), and determines whether the evaluation score (P) exceeds a predetermined threshold (T) (P>T?) (S34).

If the evaluation score (P) exceeds the predetermined threshold (T) (S34: Yes), the relationship construction unit 33 moves on to S41. If the evaluation score (P) does not exceed the predetermined threshold (T) (S53: No), the relationship construction unit 33 returns to S32.

After S33, the relationship construction unit 33 also performs attribute value evaluation by comparing word strings input from the sets of the profile information 21 to be compared with each other (S35). Specifically, the relationship construction unit 33 compares the word strings with each other, and determines whether the word strings have a word mismatch, a logic mismatch, or a word/numerical value mismatch.

In the case of a word mismatch, the relationship construction unit 33 determines the evaluation value to be P P+f(L)n₅ (S35a). In the case of a logic match, however, the relationship construction unit 33 determines the evaluation value to be P=P+f(L)n₆ (S35b). Further, in the case of a word/numerical value match, the relationship construction unit 33 determines the evaluation value to be P=P+f(L)n₇ (S35c).

Here, n₅, n₆, and n₇ are evaluation scores depending on a word mismatch, a logic match (for example, equal to or greater than ∘, within Δ, or the like), and a word/numerical value match, respectively. These evaluation scores are set by a user (provider) 200 or the like, as appropriate. For example, 0 is set to n₅, 3 is, set to n₆, and 4 is set to n₇, so that the weight of a word/numerical value match can be made greater than that of a logic match.

After S35, the relationship construction unit 33 determines whether all the attributes and attribute values in the sets of the profile information 21 to be compared with each other have been checked (whether attribute evaluation and attribute value evaluation have been completed) (S36). If all the attributes and attribute values have been checked (S36: Yes), the relationship construction unit 33 moves on to S37. If not all the attributes and attribute values have been checked (S36: No), on the other hand, the relationship construction unit 33 returns to S32.

In S37, the relationship construction unit 33 determines whether all the word strings to be compared have been checked. If all the word strings to be compared have been checked (S37: Yes), the relationship construction unit 33 moves on to S38. If not all the word strings to be compared have been checked (S37: No) on the other hand, the relationship construction unit 33 returns to S31.

In S38, the relationship construction unit 33 determines whether the evaluation score (P) exceeds the predetermined threshold (T) (P>T?). If the evaluation score (P) does not exceed the predetermined threshold (T) (S38: No), the relationship construction unit 33 determines that the agents 100 of the sets of the profile information 21 compared with each other have no association (commonality) or is “not associated” (S39). The relationship construction unit 33 then discards the information about the agent 100 determined to be “not associated”, without performing relationship construction (S40), and ends the process.

If the evaluation score (P) exceeds the predetermined threshold (T) (S38: Yes), the relationship construction unit 33 determines that the agents 100 of the sets of the profile information 21 compared with each other have association (commonality) or is “associated” (S41). The relationship construction unit 33 then performs confirmation (an access right request) from the target person (user (provider) 200) to the agents 100 determined to be “associated” (S42). The relationship construction unit 33 then performs relationship construction, and ends the process.

Next, a third example process relating to relationship construction is described. When a profile indicating individual features is formed with pairs of an attribute and an attribute value, there are cases where attention is paid only to a small number of attributes and attribute values in finding commonality. The third example process is an example in which importance is placed on matching words appearing in the attribute of interest and its attribute value. As illustrated in FIGS. 8C and 8D, when the process is started, the relationship construction unit 33 initializes variables (P=0, k=1) and the like to be used in the process (S50), as in S10. Here, k is an integer from 1 to K indicating attribute numbers.

The relationship construction unit 33 then compares a word with an attribute # k in the sets of profile information 21 to be compared with each other (S51). Here, the attribute # k means the number of the attribute. For example, an attribute #3 corresponds to an attribute number 3.

The relationship construction unit 33 then determines whether the attribute # k and the word match (S52). If the word and the attribute # k match (S52: Yes), the relationship construction unit 33 determines the evaluation value to be P=P+g(k)·A (S54). If the attribute # k and the word do not match (S52: No), the relationship construction unit 33 determines whether the concept of the attribute matches by referring to dictionary data (S53). If the concept matches (S53: Yes), the relationship construction unit 33 determines the evaluation value to be P=P+g(k)·A (S54).

Here, g(k) is a function of the weight at the attribute number # k. For example, in a case where the attribute number #3 is evaluated, and other attribute numbers are not evaluated, 1 is set to g(3), and 0 is set to g(i) (i≠3). Meanwhile, “·” is the symbol meaning multiplication. Further, A is the value to be multiplied in the case of attribute matching (including the concept). The function and the multiplying value are set by a user (provider) 200 or the like, as appropriate.

If the concept does not match (S53: No), the relationship construction unit 33 determines whether k=K (S55). If k is not K (S55: No) the relationship construction unit 33 increments k (S56), and returns to S51. If k=K (S55: Yes), the relationship construction unit 33 moves on to S64.

After S54, the relationship construction unit 33 compares a word with an attribute value # j in the sets of profile information 21 to be compared with each other (S57). Here, j is the number (an integer from 1 to J) of each attribute value at the same hierarchical level in the hierarchical structure. The attribute value # j means an attribute value whose attribute value number is j.

The relationship construction unit 33 then determines whether the attribute value # j and a word/logic match (S58). If the attribute value # j and the word/logic match (S58: Yes), the relationship construction unit 33 determines the evaluation value to be P=P+g(k)·B (S60). If the attribute value # j and the word/logic do not match (S58: No), the relationship construction unit 33 determines whether the concept of the attribute value matches by referring to the dictionary data (S59). If the concept matches (S59: Yes), the relationship construction unit 33 determines the evaluation value to be P=P+g(k)·C (S61). If the concept does not, match (S59; No), the relationship construction unit 33 increments j, and returns to S57.

Here, B is the value to be multiplied in a case where an attribute value and a word/logic match. Further, C is the value to be multiplied in a case where the concept of an attribute value matches. These multiplying values are set by a user (provider) 200 or the like, as appropriate.

After S60 and S61, the relationship construction unit 33 determines whether j=J (S63). If j is not J (S63: No), the relationship construction unit 33 increments j (S62), and returns to S57. If j=J (S63: Yes), the relationship construction unit 33 moves on to S64.

In S64, the relationship construction unit 33 determines whether the evaluation score (P) exceeds a predetermined threshold (T) (P>T?). If the evaluation score (P) does not exceed the predetermined threshold (T) (S64; No), the relationship construction unit 33 determines that the agents 100 of the sets of the profile information 21 compared with each other have no association (commonality) or is “not associated” (S65). The relationship construction unit 33 then discards the information about the agent 100 determined to be “not associated”, without performing relationship construction (S66), and ends the process.

If the evaluation score (P) exceeds the predetermined threshold (T) (S64: Yes), the relationship construction unit 33 determines that the agents 100 of the sets of the profile information 21 compared with each other have association (commonality) or is “associated” (S67). The relationship construction unit 33 then performs confirmation (an access right request) from the target person (user (provider) 200) to the agents 100 determined to be “associated” (S68). The relationship construction unit 33 then performs relationship construction, and ends the process.

Referring back to FIG. 4, after S4, the notification unit 34 notifies (performs reception) the other agents 100 with which a relationship has been constructed, of a context change (an event) based on the context information 22 indicating the state of the user (provider) 200 (S5).

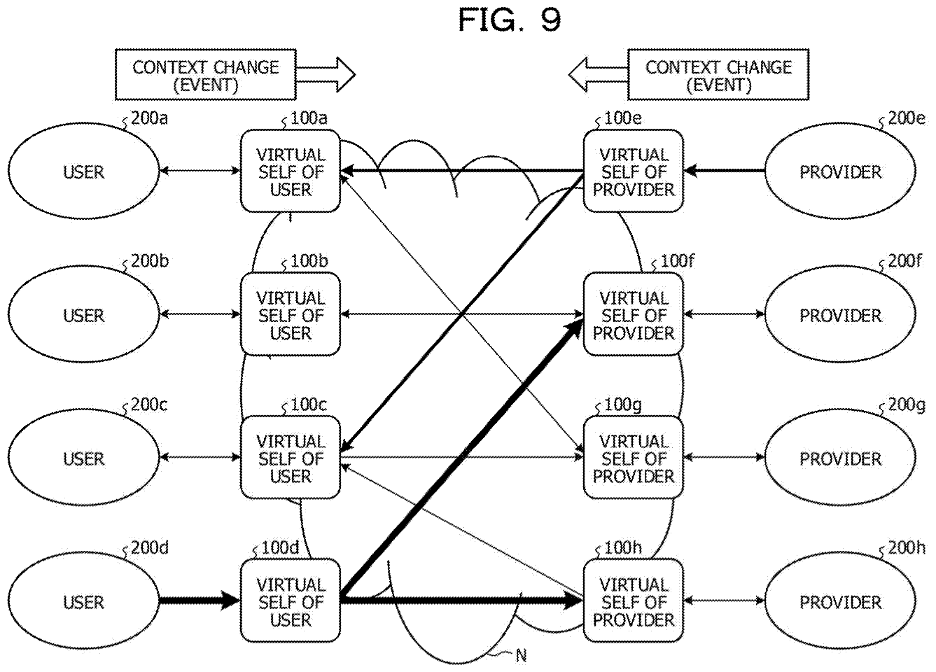

FIG. 9 is an explanatory diagram for explaining a notification of a context change. As illustrated in FIG. 9, in a case where there is a context change, the agents 100a through 100h notify other agents 100 having an established relationship of the contents of the context change as an event. For example, in a case where there is a change in the situation (context) of the user 200d, the agent 100d sends an event notification to the agents 100f and 100h that have an established relationship.

Referring back to FIG. 4, after S5, when there is an event notification from another agent 100 having an established relationship, the output unit 35 outputs the reported event (S6), and ends the process.

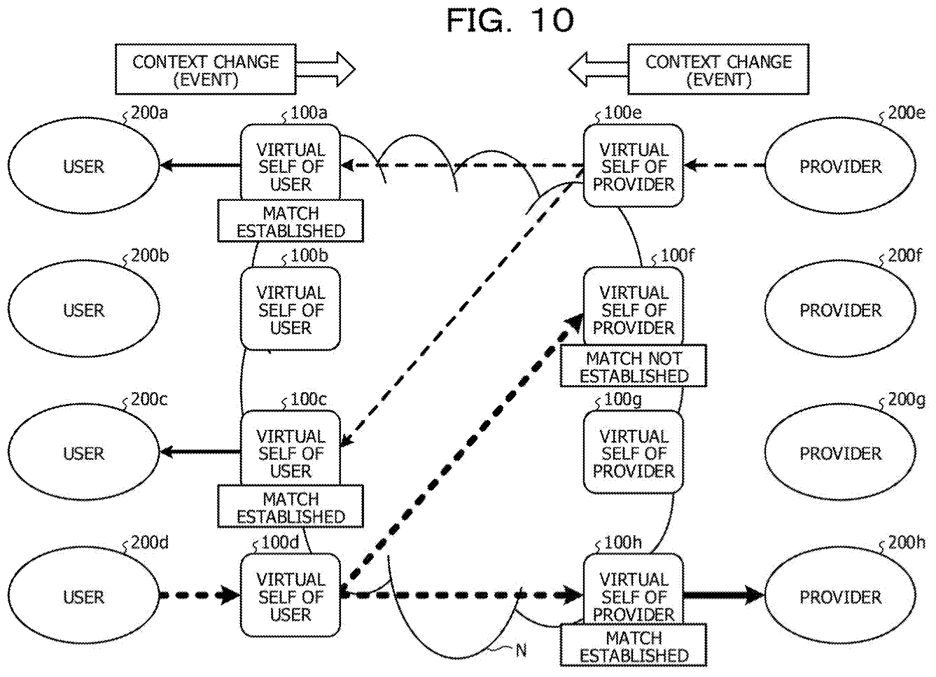

FIG. 10 is an explanatory diagram illustrating an output of a reported event. As illustrated in FIG. 10, the agents 100a and 100c receive an event notification from the agent 100e having established a relationship, and output, the reported event to the users 200a and 200c. By doing so, the users 200a and 200c can easily obtain information from many and unspecified providers and the provider 200e having high interest and association via the agent 100.

Note that the output unit 35 may output, an event that matches a preset condition. For example, in response to an event notification from the agent 100d to the agents 100f and 100h, the agent 100h outputs an event as a result of a match, and the agent 100f does not output an event as a result of a mismatch. The events to be output may be sorted out in this manner in advance.

[Specific Example Cases]

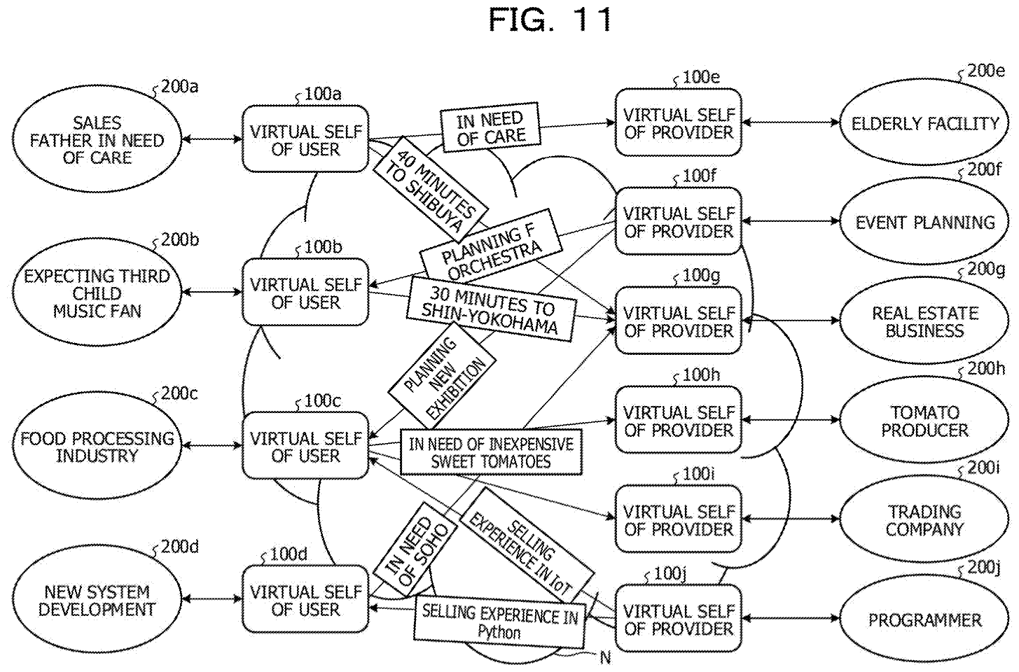

FIG. 11 is an explanatory diagram illustrating a specific example of relationship formation. In a specific example case illustrated in FIG. 11, the users 200a through 200d have set their own features that lead to requesting services and information as profiles in the agents 100a through 100d serving as virtual selves. Likewise, the providers 200e through 200j have set the features of providing services and information as profiles in the agents 100e through 100j serving as virtual selves.

For example, as illustrated in FIG. 11, a profile indicating “sales”, “father in need of care”, and the like is set in the agent 100a. Likewise, a profile indicating “expecting a third child”, “music fan”, and the like are set in the agent 100b. Also, a profile indicating “food processing industry” and the like is set in the agent 100c. Likewise, a profile indicating “new system development” and the like is set in the agent 100d.

Also, a profile indicating “elderly facility” and the like is set in the agent 100e. Likewise, a profile indicating “event planning” and the like is set in the agent 100f. Also, a profile indicating “real estate business” and the like is set in the agent 100g. Likewise, a profile indicating “tomato producer” and the like is set in the agent 100h. Also, a profile indicating “trading company” and the like is set in the agent 100i. Likewise, a profile indicating “programmer” and the like is set in the agent 100j.

The agents 100a through 100j exchange the respective set profiles, to establish communicable relationships (relationship formation) between persons having high association (commonality). For example, the agent 100a constructs a relationship with each of the agents 100e and 100g that have been determined to be associated with the agent 100a in accordance with an attribute value match or a concept match based on “in need of care”, “40 minutes to Shibuya”, and the like.

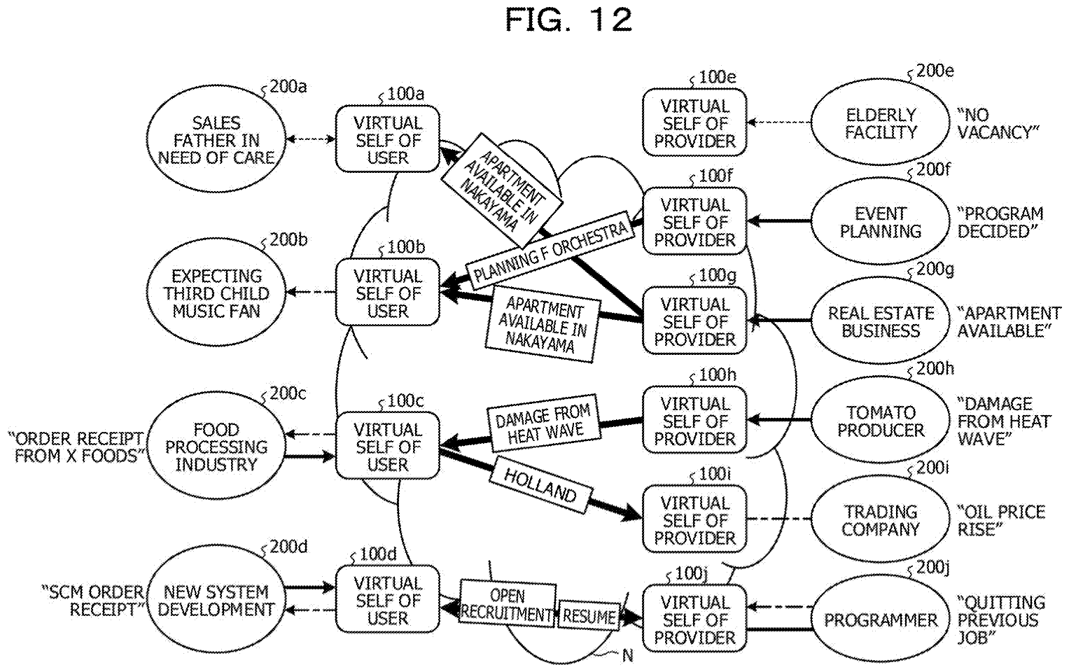

FIG. 12 is an explanatory diagram illustrating a specific example of an event notification between virtual selves that have a relationship formed. As illustrated in FIG. 12, agents 100 having a relationship formed sends an event notification according to a context change.

For example, in a case where there is a change such as “available apartment” in the state (context) of the provider 200g of the agent 100g having a relationship formed with the agent 100a, the agent 100g notifies the agent 100a of an event (apartment available in Nakayama). Having received the event notification, the agent 100a outputs the event from the agent 100g to the user 200a in a case where the condition for an output is satisfied. Thus, the user 200a can easily know about the available apartment status and the like.

The agents 100d and 100j also have a formed relationship with each other, and both the user 200d and the provider 200j have a change in the state (context), For example, on the side of the user 200d of the agent 100d, there is a state (context) change such as “SMC order receipt”. On the side of the provider 200j of the agent 100j, there is a state (context) change such as “quitting previous job”. In such a case, a notification and an output of events such as “open recruitment” and “resume” are promptly performed. Thus, matching between supply and demand is quickly aided.

FIG. 13 is an explanatory diagram illustrating an example case where a user side pulls information from a provider side. As illustrated in FIG. 13, a profile such as “address: Kyoto” is set in the agent 100a of the user 208a. Likewise, a profile such as “Yokohama office” is set in the agent 100e of the provider 200e, and a profile such as “Kyoto office” is set in the agent 100f of the provider 200f.

Accordingly, in S4 or the like, the agent 100a establishes a relationship with the agent 100f associated with “Kyoto”, When there is a change in the state (context) of the user 200a, the agent 100a then sends an event push (an event notification) to the agent 100f having the relationship established. For example, the agent 100a notifies the agent 100f of an event such as “arriving at Karasuma Exit in 5 minutes” corresponding to a context such as “about to arrive in Kyoto, heavy rain”, The agent 100a also obtains an event corresponding to the state (context) of the provider 200f from the agent 100f that has the relationship established. For example, the agent 100f notifies the agent 100a of an event such as “10 taxis waiting at Kyoto Karasuma Exit”. As a result, the user 200a can easily obtain useful information relating to his/her situation.

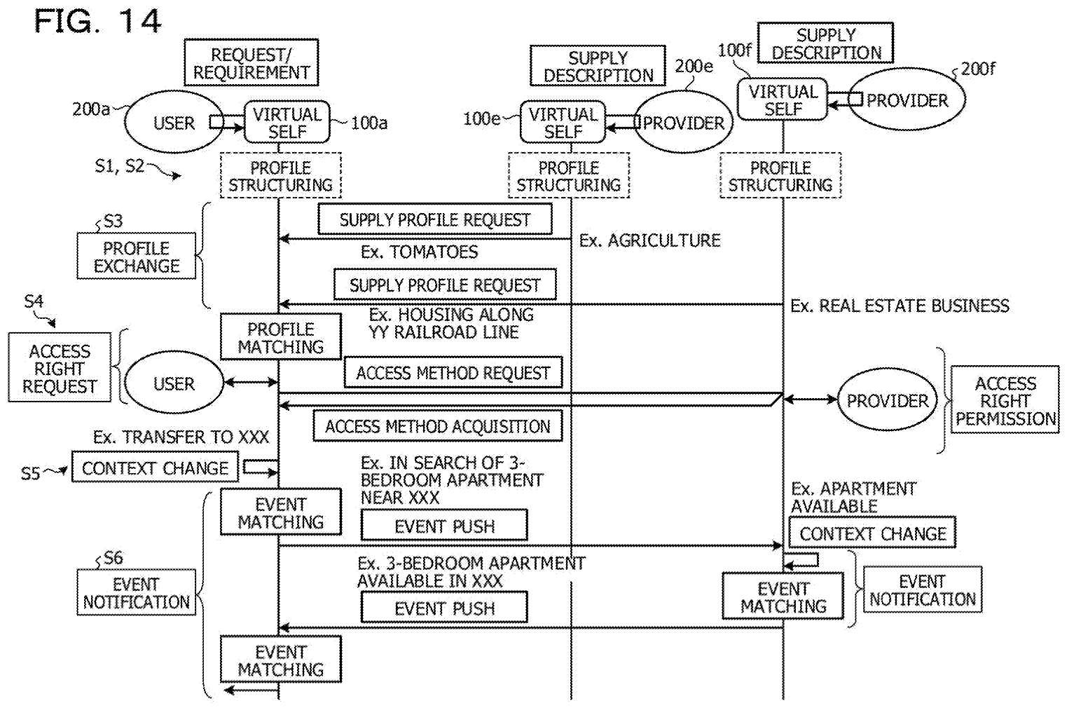

FIG. 14 is an explanatory diagram illustrating an example case of pushing a provider side. As illustrated in FIG. 14, a profile such as “agriculture” is set in the agent 100e of the provider 200e, and a profile such as “real estate business” is set in the agent 100f of the provider 200f. Accordingly, in S4 or the like, the agent 100a establishes a relationship with the agent 100f in “real estate business” having association with the features of the user 200a.

When there is a change such as “transfer to XXX” in the state (context) of the user 200a, the agent 100a then sends an event push (an event notification) to the agent 100f having the relationship established. For example, the agent 100a notifies the agent 100f of an event such as “searching for 3-bedroom apartment near XXX” corresponding to a context such as “transfer to XXX”.

When there is a change such as “available apartment” in the state (context) of the provider 200f in response to the event notification, the agent 100f sends an event push (an event notification) to the agent 100a having the relationship established. For example, the agent 100f notifies the agent 100a of an event such as “3-bedroom apartment available in XXX” corresponding to a context such as “available apartment”.

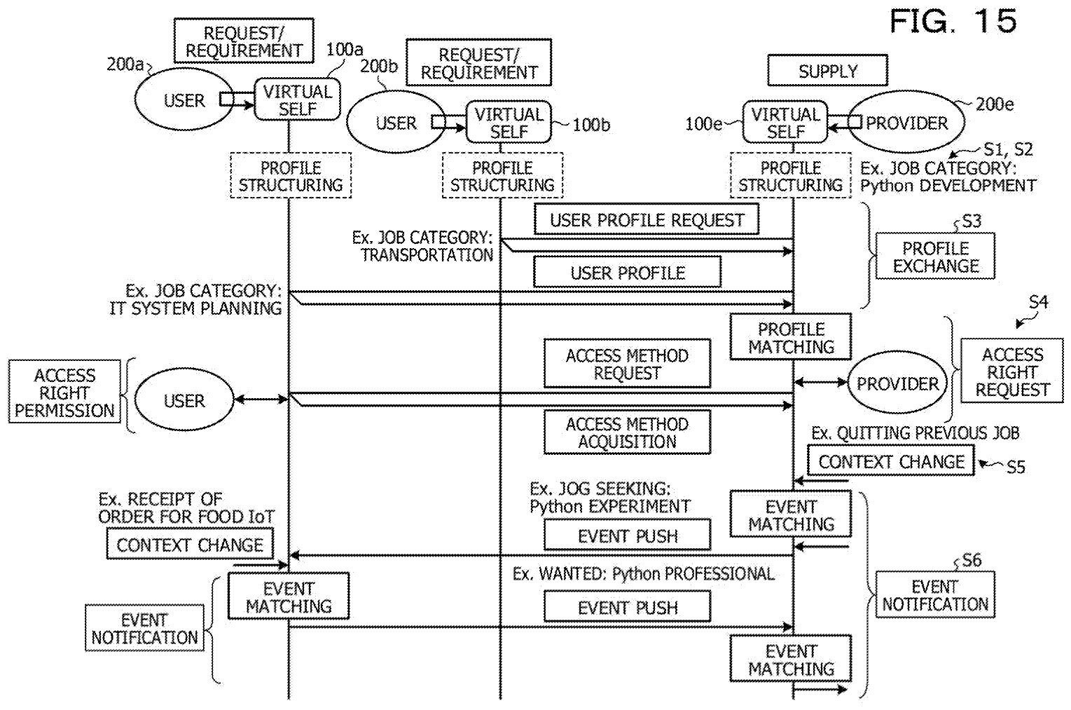

FIG. 15 is an explanatory diagram illustrating an example case where a provider side pulls information from a user side. As illustrated in FIG. 15, a profile such as “job category: IT system planning” is set in the agent 100a of the user 200a, and a profile such as “job category; transportation” is set in the agent 100b of the user 200b. Likewise, a profile such as “job category: Python development” is set in the agent 100e of the provider 200e.

Accordingly, in S4 or the like, the agent 100e establishes a relationship with the agent 100a having association with “job category: Python development”. When there is a change in the state (context) of the provider 200e, the agent 100e then sends an event push (an event notification) to the agent 100a having the relationship established.

For example, the agent 100e notifies the agent 100a of an event such as “job seeking: Python experience” corresponding to a context such as “quitting previous job”. The agent 100e also obtains an event corresponding to the state (context) of the user 200a from the agent 100a that has the relationship established. For example, the agent 100a notifies the agent 100e of an event such as “wanted: Python professional”.

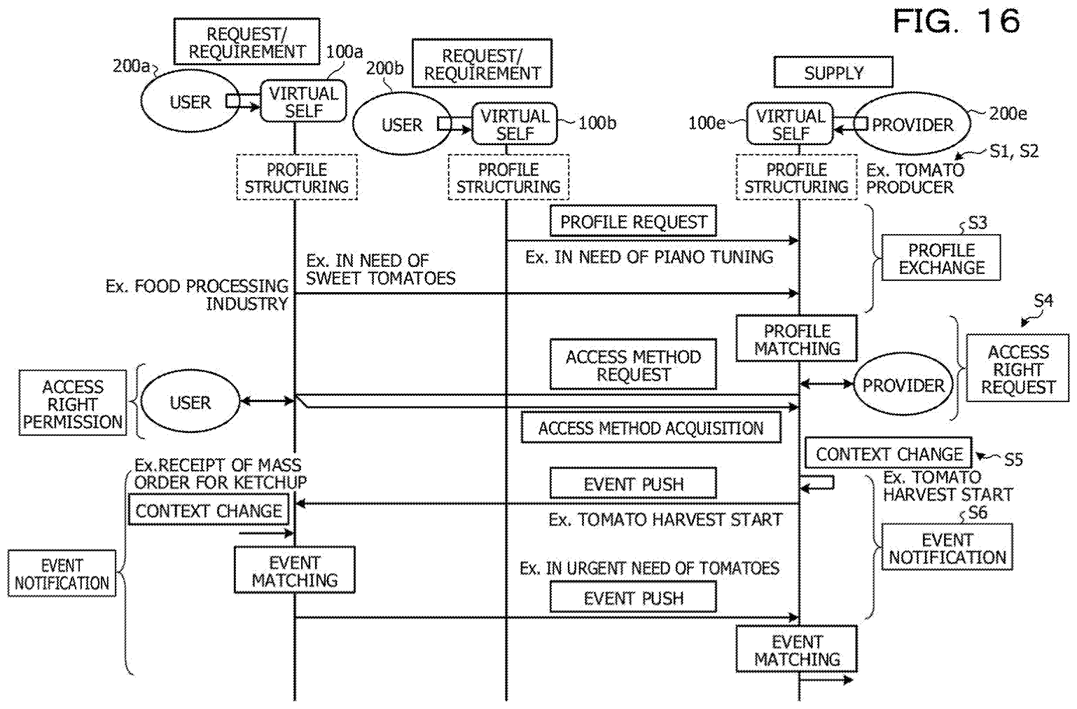

FIG. 16 is an explanatory diagram illustrating an example case where a user side pushes information, A profile such as “food processing industry” is set in the agent 100a of the user 200a, and a profile such as “in need of piano tuning” is set in the agent 100b of the user 200b. Likewise, a profile such as “tomato producer” is set in the agent 100e of the provider 200e. Accordingly, in S4 or the like, the agent 100e establishes a relationship with the agent 100a in “food processing industry” having association with the features of the provider 200e.

When there is a change such as “tomato harvest start” in the state (context) of the provider 200e, the agent 100e then sends an event push (an event notification) to the agent 100a having the relationship established. For example, the agent 100e notifies the agent 100a of an event such as “tomato harvest start”.

When there is a change such as “receipt of mass order for ketchup” in the state (context) of the user 200a in response to the event notification, the agent 100a sends an event push (an event notification) to the agent 100e having the relationship established. For example, the agent 100a notifies the agent 100e of an event such as “in urgent need of tomatoes” corresponding to a context such as “receipt of mass order for ketchup”.

[Response Time Designation]

The profile exchange unit 32 and the relationship construction unit 33 may designate a response time beforehand in a notification regarding profile exchange or relationship construction, and may retransmit the notification or performs a time-out on the process.

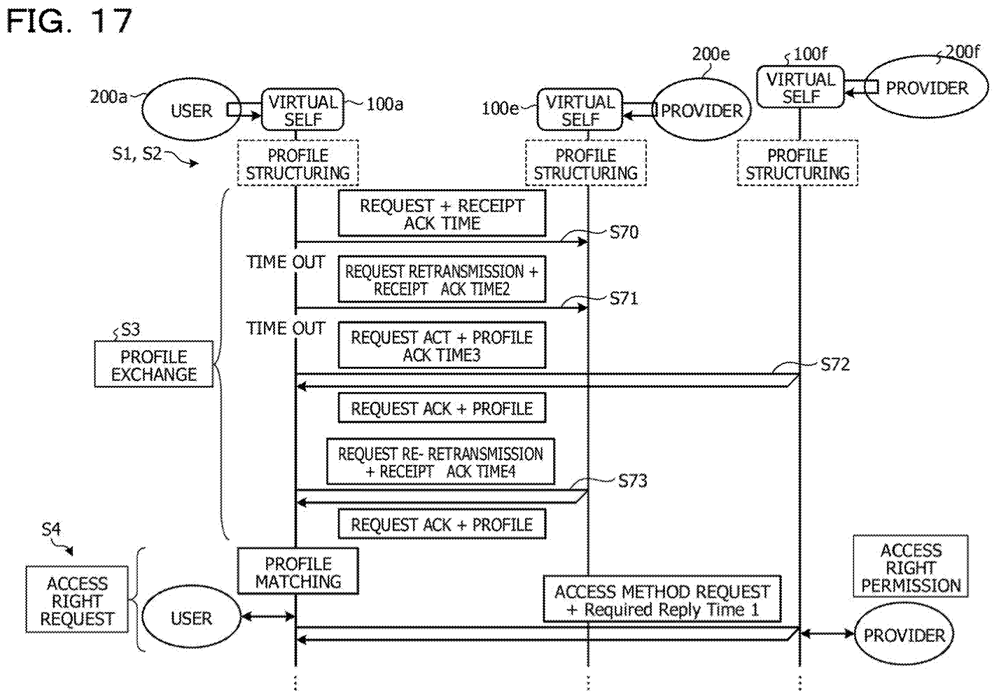

FIG. 17 is an explanatory diagram illustrating an example case in which a response time is designated. Note that, in the example illustrated in the drawing, a process at the profile exchange unit 32 (a notification process at a time of profile exchange) is performed. However, it goes without saying that a process at the relationship construction unit 33 (a notification process at a time of relationship construction) is also the same.

As illustrated in FIG. 17, in the profile exchange (S3), the profile exchange unit 32 designates a response time (ACK TIME) when requesting a profile from the agent 100e (request+RECEIPT) (S70).

Here, if there is no response at the response time (ACK TIME), the profile exchange unit 32 retransmits the profile request (request+RECEIPT) (S71). The time width at the response time (ACK TIME2) at the time of the retransmission may be different from the time width at the first response time (ACK TIME).

If there is no response to the retransmission either, the profile exchange unit 32 then Performs a time-out on the Process of exchanging Profiles with the agent 100e. Specifically, the process is temporarily stopped (suspended), or the process is forcibly ended.

For example, if there is no response to the retransmission, the profile, exchange unit 32 requests a profile from another agent 100f, to obtain a profile (S72). The profile exchange unit 32 then resumes the suspended process of exchanging profiles with the agent 100e (S73).

[Effects]

As described above, the information control device 1 includes the profile exchange unit 32, the relationship construction unit 33, the notification unit 34, and the output unit 35. The profile exchange unit 32 notifies one or a plurality of agents 100 of the profile information 21 indicating the features of the user (provider) 200, and performs profile exchange to acquire the profile information 21 about the user(s) (provider(s)) 200 of one or a plurality of agents 100. In accordance with the acquired profile information 21, the relationship construction unit 33 constructs a relationship with an agent 100 that has a profile having association with the user (provider) 200 from one or a plurality of agents 100. The notification unit 34 notifies the agent 100 having the relationship established of an event based on the context information 22 indicating the state of the user (provider) 200. When there is an event notification from the agent 100 having the relationship established, the output unit 35 outputs the reported event.

As described above, in the information control device 1, agents 100 that have established a relationship through profile exchange issue event notifications based on the context information 22. Thus, information may be exchanged as appropriate among many and unspecified agents 100 having high interest in and association with one another.

The profile exchange unit 32 also performs profile exchange based on a preset timing. Thus, the information control device 1 may exchange profiles at any appropriate timing that has been set by the user (provider) 200.

Further, in a case where there is no acquisition of a profile from one or a plurality of agents 100 within a predetermined time in response to a notification of the profile information 21, the profile exchange unit 32 retransmits the notification of the profile information 21 or performs a time-out on the process. Thus, in the information control device 1, even if communication or the like is interrupted, for example, profile exchange with one or a plurality of agents 100 will not be delayed.

Meanwhile, the relationship construction unit 33 notifies an agent 100 of a confirmation prior to relationship construction, and constructs a relationship, in accordance with a response to the confirmation notification. Thus, the information control device 1 may establish a relationship with an agent 100 that has responded to a confirmation notification.

Further, in a case where there is no response to a confirmation notification within a predetermined time, the relationship construction unit 33 retransmits the confirmation notification or performs a time-out on the process. Thus, in the information control device 1, even if communication or the like is interrupted, for example, construction of a relationship with one or a plurality of agents 100 will not be delayed.

The relationship construction unit 33 also checks with the user (provider) 200 prior to relationship construction, and, when a confirmation from the user (provider) 200 and a confirmation from an agent 100 are obtained, the relationship construction unit 33 constructs a relationship. Thus, in the information control device 1, when confirmations are obtained from the user (provider) 200 and one or a plurality of agents 100, a relationship may be constructed.

Meanwhile, in a case where, a change in the context information 22 satisfies a predetermined condition, the notification unit 34 issues a notification of the event corresponding to the change in the context information 22. Thus, when there is a predetermined change in the user (provider) 200, the information control device 1 may notify each agent 100 having a relationship constructed of the event corresponding to the change.

Meanwhile, in a case where a reported event satisfies a predetermined condition, the output unit 35 outputs the reported event. Thus, the information control device 1 may notify the user (provider) 200 of an event that satisfies a predetermined condition from among many events reported from the agents 100 each having a relationship constructed.

Meanwhile, the profile information 21 indicates the features of the user (provider) 200 with attribute values of respective attributes, and each attribute has a hierarchical structure including the lower-level attributes under the higher-level attributes. Thus, the profile information 21 may indicate the features of the user (provider) 200 with the attribute value at the respective hierarchical levels in hierarchical structures including lower-level attributes under the higher-level attributes.

Further, in the profile information 21, the attribute values of the respective attributes are written as at least one of a common noun, a proper noun, and a numerical value. Thus, the profile information 21 may indicate the features of the user (provider) 200 through the writing of at least one of a common noun, a proper noun, and a numerical value.

The information control device 1 further includes the acquisition unit 31 that generates the profile information 21 indicating the features of the user (provider) 200 in accordance with inputs from the user (provider) 200. In accordance with the profiles of one or a plurality of agents 100 in the other information control device(s) (1a through 1c and the like), the acquisition unit 31 receives inputs of the attribute values of the respective attributes included in the profile information 21 from the user (provider) 200. Thus, hi the information control device 1, the attribute values of the respective attributes included in the profile information 21 may be input in accordance with the hierarchical structures of the attributes in the profile(s) of one or a plurality of agents 100, for example.

The relationship construction unit 33 also compares the attribute values of the respective attributes in the acquired profile information 21 with the attribute values of the respective attributes in the profile information 21 indicating the features of the user (provider) 200. The relationship construction unit 33 then changes the weight to be used in determining an agent 100 to have a profile having association with the user (provider) 200, depending on which one of a common noun, a proper noun, and a numerical value the matching attribute values are of. Thus, the information control device 1 may determine an agent 100 that has a profile having association with the user (provider) 200, on the basis of the weight depending on which one of a common noun, a proper noun, and a numerical value the matching attribute values are of.

Further, in comparing the attribute values of the respective attributes, the relationship construction unit 33 changes the weight in accordance with the number of matches or mismatches of attribute values, and/or the number of matches or mismatches of concepts represented by attribute values, and/or the hierarchical positions of matching attribute values in the hierarchical structure. Thus, the information control device 1 may determine an agent 100 that has a profile having association with the user (provider) 200, on the basis of the weight depending on the number of matches or mismatches of attribute values, the number of matches or mismatches of concepts represented by attribute values, the hierarchical positions of matching attribute values in the hierarchical structure, and the like.

Further, profile exchange or event notification in the information control device 1 is performed by broadcast or multicast to one or a plurality of agents 100 or an agent 100 having a relationship established. Thus, the information control device 1 may perform profile exchange or event notification by broadcast or multicast.

[Other Aspects]

Note that each of the constituent elements of the respective components illustrated in the drawings is not necessarily physically designed as illustrated in the drawings. In other words, specific aspects of separation and integration of the respective components are not limited to the illustrated forms, and all or some of the components may be functionally or physically separated and integrated in any appropriate unit depending on various loads, usage states, or the like. For example, the profile exchange unit 32 and the relationship construction unit 33, or the notification unit 34 and the output unit 35 may be integrated. Furthermore, the order of the respective processes illustrated in the drawings is not limited to the order described above, and the processes may be concurrently performed or may be performed in different order, as long as there is no contradiction in the process contents.

Further, all or some of the various processing functions to be executed by each device may be executed by a CPU (or a microcomputer such as an MPU or a micro controller unit (MCU)). Furthermore, it is needless to say that all or some of the various processing functions may be executed in a program to be analyzed and executed by a CPU (or a microcomputer, such as an MPU or an MCU), or in hardware formed with wired logics.

[Hardware Configuration]

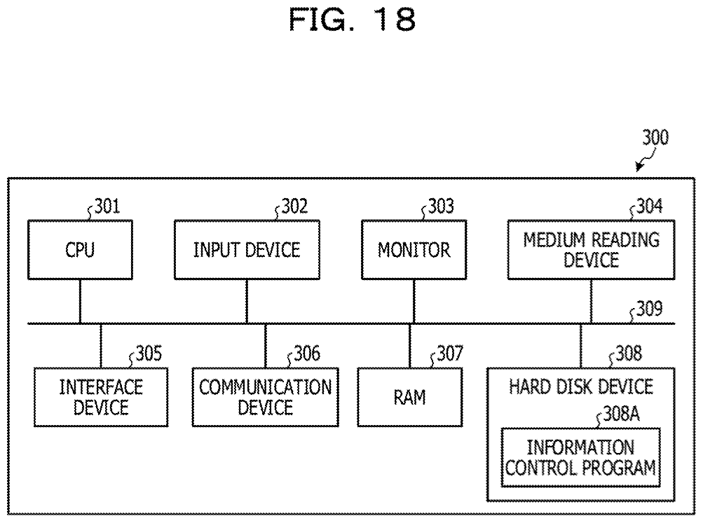

The various processing functions described above in the embodiment may be realized by execution of a prepared program in a computer. Therefore, in the description below, an example of a computer that executes a program having the same functions are those of the above embodiment will be described. FIG. 18 is a diagram illustrating an example of a computer that executes an information control program.

As illustrated in FIG. 18, a computer 300 includes a CPU 301 that performs various kinds of arithmetic processing, an input device 302 that receives data inputs, and a monitor 303. The computer 300 also includes a medium reading device 304 that reads a program and the like from a storage medium, an interface device 305 that connects to various kinds of devices, and a communication device 306 that wiredly or wirelessly connects to other information processing devices and the like. The computer 300 further includes a RAM 307 that temporarily stores various kinds of information, and a hard disk device 308. Meanwhile, each of the devices 301 through 308 is connected to a bus 309.

The hard disk device 308 stores an information control program 308A having the same functions as the respective processing units: the acquisition unit 31, the profile exchange unit 32, the relationship construction unit 33, the notification unit 34, and the output unit 35 illustrated in FIG. 1. The hard disk device 308 also stores various kinds of data for realizing the profile information 21, the context information 22, and the association information 23. The input device 302 receives, inputs of various kinds of information such as operating information from the manager of the computer 300, for example. The monitor 303 displays various kinds of screens such as a display screen to the manager of the computer 300, for example. The interface device 305 is connected to a printing device or the like, for example. The communication device 306 has the same functions as the communication unit 10 illustrated in FIG. 1, for example. The communication device 306 is connected to a network (not illustrated), and exchanges various kinds of information with other information control devices.

The CPU 301 reads the information control program 308A stored in the hard disk device 308, and loads the information control program 308A into the RAM 307. The CPU 301 then executes the information control program 308A, to perform various kinds of processes. The information control program 308A may also cause the computer 300 to function as the acquisition unit 31, the profile exchange unit 32, the relationship construction unit 33, the notification unit 34, and the output unit 35 illustrated in FIG. 1.

Note that the information control program 308A described above is not necessarily stored in the hard disk device 308. For example, the computer 300 may read and execute the information control program 308A stored in a storage medium that can be read by the computer 300. The storage medium that can be read by the computer 300 corresponds to a portable recording medium such as a compact disc (CD)-ROM, a digital versatile disc (DVD), or a universal serial bus (USB) memory, a semiconductor memory such as a flash memory, a hard disk drive, or the like, for example. Furthermore, the information control program 308A may be stored in a device connected to a public line, the Internet, a LAN, or the like, and, the computer 300 may read and execute the information control program 308A from the device.

All examples and, conditional language provided herein are intended for the pedagogical purposes of aiding the reader in understanding the invention and the concepts contributed by the inventor to further the art, and are not to be construed as limitations to such specifically recited examples and conditions nor does the or of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor included in a computer to execute a process, the process comprising:
transmitting a first profile indicating a feature of a first user to a device;
acquiring a second profile indicating a feature of a second user from the device;
establishing communication with the device, n accordance with association between the first profile and the acquired second profile; and
notifying the device having the communication established of event information corresponding to a context indicating a state of the first user.

2. The no transitory computer-readable storage medium according to claim 1, wherein the process further comprises:
receiving event information corresponding to a state of the se and user from the device having the communication established; and
outputting the received event information to a display owned by the first user.

3. The non-transitory computer-readable storage medium according to claim 1, wherein a process of establishing the communication includes:
transmitting an access request to the device; and
receiving an access permission from the device.

4. The non-transitory computer-readable storage medium according to claim 1, wherein the first profile is transmitted at a preset timing.

5. The non-transitory computer-readable storage medium according to claim 1, wherein the process further comprises:
transmitting request information indicating a request for acquisition of the second profile, to the device; and
receiving a response to the request from the device.

6. The non-transitory computer-readable storage medium according to claim 5, wherein the process further comprises
retransmitting the request information, when there is no response from the device to the request information within a predetermined time.

7. The non-transitory computer-readable storage medium according to claim 5, wherein the process further comprises
performing a time-out on a process of acquiring the second profile, when there is no response from the device to the request information within a predetermined time.

8. The non-transitory computer-readable storage medium according to claim 1, wherein
when a change in the context satisfies a predetermined condition, the event information is notified depending on the change.

9. The non-transitory computer-readable storage medium according to claim 2, wherein
when the received event information satisfies a predetermined condition, the event information to be output to the display is output to the display.

10. The non-transitory computer-readable storage medium according to claim 1, wherein
the first profile indicates the feature of the first user with a plurality of attributes, and attribute values in the respective, plurality of attributes, and
the plurality of attributes has a hierarchical structure including lower-level attributes under higher-level attribute values.

11. The non-transitory computer-readable storage medium according to claim 10, wherein
the attribute values are written as at least one of a common noun, a proper noun, a numerical value, and a logic.

12. The non-transitory computer-readable storage medium according to claim 10, wherein a process of establishing the communication includes:
comparing the attribute values of the respective attributes in the acquired second profile with the attributes and the attribute values of the respective attributes in the first profile; and
changing a weight or a word of interest to be used in determining the association depending on which one of a common noun, a proper noun, a numerical value, and a logic written contents of matching attribute values are of.

13. The non-transitory computer-readable storage medium according to claim 12, wherein the process of establishing the communication includes,
in comparing the attribute values of the respective attributes, changing the weight in accordance with at least one of the number of matches or mismatches of words indicated by the attribute values, the number of matches or mismatches of concepts indicated by the attribute values, and a hierarchical position of matching attribute values in the hierarchical structure.

14. The non-transitory computer-readable storage medium according to claim 1, wherein
the first profile is transmitted to the device by broadcast or multicast in a lower network layer.

15. An information control method implemented by a computer, the information control method comprising:
transmitting a first profile indicating a feature of a first user to a device;
acquiring a second profile indicating a feature of a second user from the device,
establishing communication with the device, in accordance with association between the first profile and the acquired second profile; and
notifying the device having the communication established of event information corresponding to a context indicating a state of the first user.

16. The information control method according to claim 15, wherein the process further comprises:
receiving event information corresponding to a state of the second user from the device having the communication established; and
outputting the received event information to a display owned by the first user.

17. The information control method according to claim 15, wherein
a process of establishing the communication includes:
transmitting an access request to the device; and
receiving an access permission from the device.

18. An information control device comprising:
a memory; and
circuitry coupled to the memory and configured to:
transmit a first profile indicating a feature of a first user to a device;
acquire a second profile indicating a feature of a second user from the device,
establish communication with the device, in accordance with association between the first profile and the acquired second profile; and
notify the device having the communication established of event information corresponding to a context indicating a state of the first user.

19. The information control device according to claim 18, wherein the circuitry is configured to:
receive event information corresponding to a state of the second user from the device having the communication established; and
output the received event information to a display owned by the first user.

20. The information control device according to claim 15, wherein
a process of establishing the communication includes:
transmitting an access request to the device; and
receiving an access permission from the device.
